(19) United States
(12) Patent Application Publication
(10) Pub. No.: US 2026/0270824 A1
(43) Pub. Date: Sep. 10, 2026

(54) METHOD AND APPARATUS FOR CELL RESELECTION BASED ON PRECONFIGURATION IN A WIRELESS COMMUNICATION SYSTEM

(71) Applicant: LG ELECTRONICS INC., Seoul (KR)

(72) Inventor: Sangwon KIM, Seoul (KR)

(73) Assignee: LG ELECTRONICS INC., Seoul (KR)

(21) Appl. No.: 19/491,312

(22) PCT Filed: Jun. 10, 2024
(86) PCT No.: PCT/KR2024/007871

§ 371 Date: Dec. 8, 2025

Related U.S. Application Data
(60) Provisional application No. 63/521,351, filed on Jun. 16, 2023.

(51) Int. Cl. H04W 36/08; H04W 76/27

(52) U.S. Cl. CPC H04W 36/08; H04W 76/27

(57) ABSTRACT

A method and apparatus for cell re-selection based on pre-configuration in a wireless communication system is provided. The method comprises: receiving a pre-configuration for a candidate target cell; increasing a priority of the candidate target cell over one or more neighbor cells for cell re-selection based on the pre-configuration for the candidate target cell; and performing cell re-selection considering the priority of the candidate target cell.

### CROSS-REFERENCE TO RELATED APPLICATIONS

This application is the National Stage filing under 35 U.S.C. 371 of International Application No. PCT/KR2024/007871, filed on Jun. 10, 2024, which claims the benefit of U.S. Provisional Application No. 63/521,351 filed on Jun. 16, 2023, the contents of which are all hereby incorporated by reference herein in their entireties.

### TECHNICAL FIELD

The present disclosure relates to a method and apparatus for cell re-selection based on pre-configuration in a wireless communication system.

### BACKGROUND

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in international telecommunication union (ITU) and 3GPP to develop requirements and specifications for new radio (NR) systems. 3GPP has to identify and develop the technology components needed for successfully standardizing the new RAT timely satisfying both the urgent market needs, and the more long-term requirements set forth by the ITU radio communication sector (ITU-R) international mobile telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced mobile broadband (eMBB), massive machine-type-communications (mMTC), ultra-reliable and low latency communications (URLLC), etc. The NR shall be inherently forward compatible.

### SUMMARY

When resuming the RRC connection, if UE has a stored pre-configuration associated with the resume target cell, the UE can boost the DL/UL performance by applying the pre-configuration upon RRC resume.

Thus, UE in RRC_INACTIVE is better to select a neighbor cell as a new serving cell, for which the pre-configuration is stored, if possible. However, though the pre-configuration is stored for several neighbor cells, the UE may select a neighbor cell for which no pre-configuration is stored.

Therefore, studies for cell re-selection based on pre-configuration in a wireless communication system are required.

In an aspect, a method performed by a wireless device in a wireless communication system is provided. The method comprises: receiving a pre-configuration for a candidate target cell; increasing a priority of the candidate target cell over one or more neighbor cells for cell re-selection based on the pre-configuration for the candidate target cell; and performing cell re-selection considering the priority of the candidate target cell.

In another aspect, an apparatus for implementing the above method is provided.

The present disclosure can have various advantageous effects.

According to some embodiments of the present disclosure, the wireless device could perform cell re-selection efficiently by considering pre-configuration.

For example, a wireless device can apply the configuration which is optimized for the resume target cell (for example, CA or DC), upon RRC resume by selecting a cell for which the pre-configuration is stored.

In other words, a wireless device can increasing priority of a specific cell, when the wireless device has the pre-configuration for the specific cell. Thus, the wireless device could efficiently perform cell re-selection considering the stored pre-configuration.

According to some embodiments of the present disclosure, the wireless communication system could provide an efficient solution for cell re-selection considering pre-configuration.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF THE DRAWINGS

FIG. 1 shows an example of a communication system to which implementations of the present disclosure is applied.

FIG. 2 shows an example of wireless devices to which implementations of the present disclosure is applied.

FIG. 3 shows an example of a wireless device to which implementations of the present disclosure is applied.

FIG. 4 shows another example of wireless devices to which implementations of the present disclosure is applied.

FIG. 5 shows an example of UE to which implementations of the present disclosure is applied.

FIGS. 6 and 7 show an example of protocol stacks in a 3GPP based wireless communication system to which implementations of the present disclosure is applied.

FIG. 8 shows a frame structure in a 3GPP based wireless communication system to which implementations of the present disclosure is applied.

FIG. 9 shows a data flow example in the 3GPP NR system to which implementations of the present disclosure is applied.

FIG. 10 shows an example of a successful RRC connection resume procedure.

FIG. 11 shows an example of a successful RRC connection resume fallback to RRC connection establishment.

FIG. 12 shows an example of a successful RRC connection resume followed by network release.

FIG. 13 shows an example of a successful RRC connection resume followed by network suspend.

FIG. 14 shows an example of a network rejection for the RRC connection resume.

FIGS. 15a, 15b, and 15c show an example of a conditional SN change procedure initiated by SN.

FIG. 16 shows an example of a method for cell re-selection based on pre-configuration in a wireless communication system, according to some embodiments of the present disclosure.

FIG. 17 shows an example of a method for cell prioritization based on pre-configuration.

### DETAILED DESCRIPTION

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-FDMA in UL. LTE-advanced (LTE-A) is an evolved version of 3GPP LTE.

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

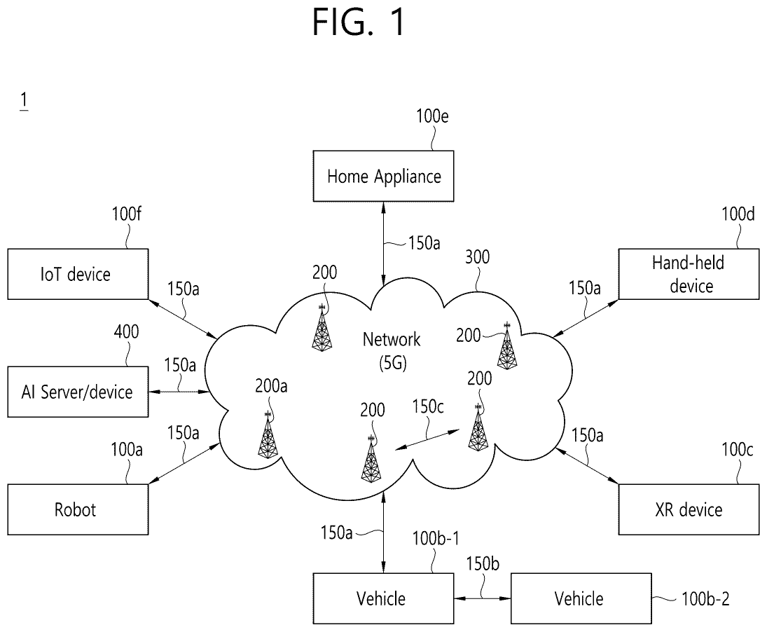

FIG. 1 shows an example of a communication system to which implementations of the present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced mobile broadband (eMBB), (2) a category of massive machine type communication (mMTC), and (3) a category of ultra-reliable and low latency communications (URLLC).

Partial use cases may require a plurality of categories for optimization and other use cases may focus only upon one key performance indicator (KPI). 5G supports such various use cases using a flexible and reliable method.

eMBB far surpasses basic mobile Internet access and covers abundant bidirectional work and media and entertainment applications in cloud and augmented reality. Data is one of 5G core motive forces and, in a 5G era, a dedicated voice service may not be provided for the first time. In 5G, it is expected that voice will be simply processed as an application program using data connection provided by a communication system. Main causes for increased traffic volume are due to an increase in the size of content and an increase in the number of applications requiring high data transmission rate. A streaming service (of audio and video), conversational video, and mobile Internet access will be more widely used as more devices are connected to the Internet. These many application programs require connectivity of an always turned-on state in order to push real-time information and alarm for users. Cloud storage and applications are rapidly increasing in a mobile communication platform and may be applied to both work and entertainment. The cloud storage is a special use case which accelerates growth of uplink data transmission rate. 5G is also used for remote work of cloud. When a tactile interface is used, 5G demands much lower end-to-end latency to maintain user good experience. Entertainment, for example, cloud gaming and video streaming, is another core element which increases demand for mobile broadband capability. Entertainment is essential for a smartphone and a tablet in any place including high mobility environments such as a train, a vehicle, and an airplane. Other use cases are augmented reality for entertainment and information search. In this case, the augmented reality requires very low latency and instantaneous data volume.

In addition, one of the most expected 5G use cases relates a function capable of smoothly connecting embedded sensors in all fields, i.e., mMTC. It is expected that the number of potential Internet-of-things (IoT) devices will reach 204 hundred million up to the year of 2020. An industrial IoT is one of categories of performing a main role enabling a smart city, asset tracking, smart utility, agriculture, and security infrastructure through 5G.

URLLC includes a new service that will change industry through remote control of main infrastructure and an ultra-reliable/available low-latency link such as a self-driving vehicle. A level of reliability and latency is essential to control a smart grid, automatize industry, achieve robotics, and control and adjust a drone.

5G is a means of providing streaming evaluated as a few hundred megabits per second to gigabits per second and may complement fiber-to-the-home (FTTH) and cable-based broadband (or DOCSIS). Such fast speed is needed to deliver TV in resolution of 4K or more (6K, 8K, and more), as well as virtual reality and augmented reality. Virtual reality (VR) and augmented reality (AR) applications include almost immersive sports games. A specific application program may require a special network configuration. For example, for VR games, gaming companies need to incorporate a core server into an edge network server of a network operator in order to minimize latency.

Automotive is expected to be a new important motivated force in 5G together with many use cases for mobile communication for vehicles. For example, entertainment for passengers requires high simultaneous capacity and mobile broadband with high mobility. This is because future users continue to expect connection of high quality regardless of their locations and speeds. Another use case of an automotive field is an AR dashboard. The AR dashboard causes a driver to identify an object in the dark in addition to an object seen from a front window and displays a distance from the object and a movement of the object by overlapping information talking to the driver. In the future, a wireless module enables communication between vehicles, information exchange between a vehicle and supporting infrastructure, and information exchange between a vehicle and other connected devices (e.g., devices accompanied by a pedestrian). A safety system guides alternative courses of a behavior so that a driver may drive more safely drive, thereby lowering the danger of an accident. The next stage will be a remotely controlled or self-driven vehicle. This requires very high reliability and very fast communication between different self-driven vehicles and between a vehicle and infrastructure. In the future, a self-driven vehicle will perform all driving activities and a driver will focus only upon abnormal traffic that the vehicle cannot identify. Technical requirements of a self-driven vehicle demand ultra-low latency and ultra-high reliability so that traffic safety is increased to a level that cannot be achieved by human being.

A smart city and a smart home/building mentioned as a smart society will be embedded in a high-density wireless sensor network. A distributed network of an intelligent sensor will identify conditions for costs and energy-efficient maintenance of a city or a home. Similar configurations may be performed for respective households. All of temperature sensors, window and heating controllers, burglar alarms, and home appliances are wirelessly connected. Many of these sensors are typically low in data transmission rate, power, and cost. However, real-time HD video may be demanded by a specific type of device to perform monitoring.

Consumption and distribution of energy including heat or gas is distributed at a higher level so that automated control of the distribution sensor network is demanded. The smart grid collects information and connects the sensors to each other using digital information and communication technology so as to act according to the collected information. Since this information may include behaviors of a supply company and a consumer, the smart grid may improve distribution of fuels such as electricity by a method having efficiency, reliability, economic feasibility, production sustainability, and automation. The smart grid may also be regarded as another sensor network having low latency.

Mission critical application (e.g., e-health) is one of 5G use scenarios. A health part contains many application programs capable of enjoying benefit of mobile communication. A communication system may support remote treatment that provides clinical treatment in a faraway place. Remote treatment may aid in reducing a barrier against distance and improve access to medical services that cannot be continuously available in a faraway rural area. Remote treatment is also used to perform important treatment and save lives in an emergency situation. The wireless sensor network based on mobile communication may provide remote monitoring and sensors for parameters such as heart rate and blood pressure.

Wireless and mobile communication gradually becomes important in the field of an industrial application. Wiring is high in installation and maintenance cost. Therefore, a possibility of replacing a cable with reconstructible wireless links is an attractive opportunity in many industrial fields. However, in order to achieve this replacement, it is necessary for wireless connection to be established with latency, reliability, and capacity similar to those of the cable and management of wireless connection needs to be simplified. Low latency and a very low error probability are new requirements when connection to 5G is needed.

Logistics and freight tracking are important use cases for mobile communication that enables inventory and package tracking anywhere using a location-based information system. The use cases of logistics and freight typically demand low data rate but require location information with a wide range and reliability.

Referring to FIG. 1, the communication system 1 includes wireless devices 100a to 100f, base stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using radio access technology (RAT) (e.g., 5G new RAT (NR)) or LTE) and may be referred to as communication/radio/5G devices. The wireless devices 100a to 100f may include, without being limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle having a wireless communication function, an autonomous driving vehicle, and a vehicle capable of performing communication between vehicles. The vehicles may include an unmanned aerial vehicle (UAV) (e.g., a drone). The XR device may include an AR/VR/Mixed Reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called user equipments (UEs). A UE may include, for example, a cellular phone, a smartphone, a laptop computer, a digital broadcast terminal, a personal digital assistant (PDA), a portable multimedia player (PMP), a navigation system, a slate personal computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The UAV may be, for example, an aircraft aviated by a wireless control signal without a human being onboard.

The VR device may include, for example, a device for implementing an object or a background of the virtual world. The AR device may include, for example, a device implemented by connecting an object or a background of the virtual world to an object or a background of the real world. The MR device may include, for example, a device implemented by merging an object or a background of the virtual world into an object or a background of the real world. The hologram device may include, for example, a device for implementing a stereoscopic image of 360 degrees by recording and reproducing stereoscopic information, using an interference phenomenon of light generated when two laser lights called holography meet.

The public safety device may include, for example, an image relay device or an image device that is wearable on the body of a user.

The MTC device and the IoT device may be, for example, devices that do not require direct human intervention or manipulation. For example, the MTC device and the IoT device may include smartmeters, vending machines, thermometers, smartbulbs, door locks, or various sensors.

The medical device may be, for example, a device used for the purpose of diagnosing, treating, relieving, curing, or preventing disease. For example, the medical device may be a device used for the purpose of diagnosing, treating, relieving, or correcting injury or impairment. For example, the medical device may be a device used for the purpose of inspecting, replacing, or modifying a structure or a function. For example, the medical device may be a device used for the purpose of adjusting pregnancy. For example, the medical device may include a device for treatment, a device for operation, a device for (in vitro) diagnosis, a hearing aid, or a device for procedure.

The security device may be, for example, a device installed to prevent a danger that may arise and to maintain safety. For example, the security device may be a camera, a closed-circuit TV (CCTV), a recorder, or a black box.

The FinTech device may be, for example, a device capable of providing a financial service such as mobile payment. For example, the FinTech device may include a payment device or a point of sales (POS) system.

The weather/environment device may include, for example, a device for monitoring or predicting a weather/environment.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., vehicle-to-vehicle (V2V)/vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or device-to-device (D2D) communication) 150b, inter-base station communication 150c (e.g., relay, integrated access and backhaul (IAB)), etc. The wireless devices 100a to 100f and the BSs 200/the wireless devices 100a to 100f may transmit/receive radio signals to/from each other through the wireless 150b and 150c. For example, the wireless communication/connections 150a, communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

Here, the radio communication technologies implemented in the wireless devices in the present disclosure may include narrowband internet-of-things (NB-IoT) technology for low-power communication as well as LTE, NR and 6G. For example, NB-IoT technology may be an example of low power wide area network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced machine type communication (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate personal area networks (PANs) associated with small/low-power digital communication based on various specifications such as IEEE 802.15.4 and may be called various names.

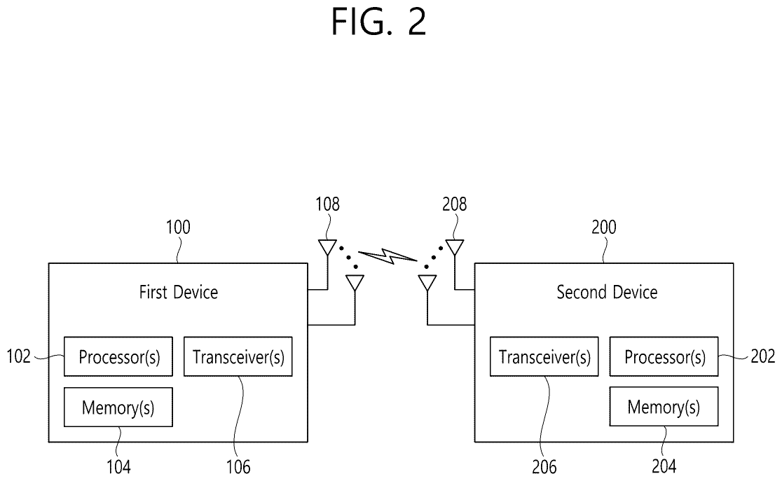

FIG. 2 shows an example of wireless devices to which implementations of the present disclosure is applied.

Referring to FIG. 2, a first wireless device 100 and a second wireless device 200 may transmit/receive radio signals to/from an external device through a variety of RATs (e.g., LTE and NR). In FIG. 2, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, suggestions, methods and/or operational flowcharts described in the present disclosure. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver(s) 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, suggestions, methods and/or operational flowcharts described in the present disclosure. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with radio frequency (RF) unit(s). In the present disclosure, the first wireless device 100 may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, suggestions, methods and/or operational flowcharts described in the present disclosure. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, suggestions, methods and/or operational flowcharts described in the present disclosure. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as physical (PHY) layer, media access control (MAC) layer, radio link control (RLC) layer, packet data convergence protocol (PDCP) layer, radio resource control (RRC) layer, and service data adaptation protocol (SDAP) layer). The one or more processors 102 and 202 may generate one or more protocol data units (PDUs) and/or one or more service data unit (SDUs) according to the descriptions, functions, procedures, suggestions, methods and/or operational flowcharts disclosed in the present disclosure. The one or more processors 102 and 202 may generate messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. descriptions, functions, procedures, suggestions, methods and/or operational flowcharts disclosed in the present disclosure may be implemented using firmware or software and the firmware or software may be configured to include the modules, procedures, or functions. Firmware or software configured to perform the descriptions, functions, procedures, suggestions, methods and/or operational flowcharts disclosed in the present disclosure may be included in the one or more processors 102 and 202 or stored in the one or more memories 104 and 204 so as to be driven by the one or more processors 102 and 202. The descriptions, functions, procedures, suggestions, methods and/or operational flowcharts disclosed in the present disclosure may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas may be a plurality of physical antennas or a plurality of logical antennas (e.g., antenna ports).

The one or more transceivers 106 and 206 may convert received radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the transceivers 106 and 206 can up-convert OFDM baseband signals to a carrier frequency by their (analog) oscillators and/or filters under the control of the processors 102 and 202 and transmit the up-converted OFDM signals at the carrier frequency. The transceivers 106 and 206 may receive OFDM signals at a carrier frequency and down-convert the OFDM signals into OFDM baseband signals by their (analog) oscillators and/or filters under the control of the transceivers 102 and 202.

In the implementations of the present disclosure, a UE may operate as a transmitting device in uplink (UL) and as a receiving device in downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be configured to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be configured to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

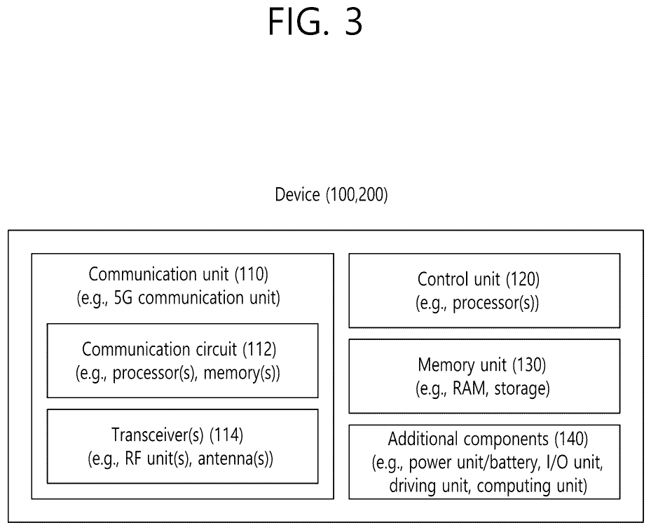

FIG. 3 shows an example of a wireless device to which implementations of the present disclosure is applied.

The wireless device may be implemented in various forms according to a use-case/service (refer to FIG. 1).

Referring to FIG. 3, wireless devices 100 and 200 may correspond to the wireless devices 100 and 200 of FIG. 2 and may be configured by various elements, components, units/portions, and/or modules. For example, each of the wireless devices 100 and 200 may include a communication unit 110, a control unit 120, a memory unit 130, and additional components 140. The communication unit 110 may include a communication circuit 112 and transceiver(s) 114. For example, the communication circuit 112 may include the one or more processors 102 and 202 of FIG. 2 and/or the one or more memories 104 and 204 of FIG. 2. For example, the transceiver(s) 114 may include the one or more transceivers 106 and 206 of FIG. 2 and/or the one or more antennas 108 and 208 of FIG. 2. The control unit 120 is electrically connected to the communication unit 110, the memory 130, and the additional components 140 and controls overall operation of each of the wireless devices 100 and 200. For example, the control unit 120 may control an electric/mechanical operation of each of the wireless devices 100 and 200 based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of the wireless devices 100 and 200. For example, the additional components 140 may include at least one of a power unit/battery, input/output (I/O) unit (e.g., audio I/O port, video I/O port), a driving unit, and a computing unit. The wireless devices 100 and 200 may be implemented in the form of, without being limited to, the robot (100a of FIG. 1), the vehicles (100b-1 and 100b-2 of FIG. 1), the XR device (100c of FIG. 1), the hand-held device (100d of FIG. 1), the home appliance (100e of FIG. 1), the IoT device (100f of FIG. 1), a digital broadcast terminal, a hologram device, a public safety device, an MTC device, a medicine device, a FinTech device (or a finance device), a security device, a climate/environment device, the AI server/device (400 of FIG. 1), the BSs (200 of FIG. 1), a network node, etc. The wireless devices 100 and 200 may be used in a mobile or fixed place according to a use-example/service.

In FIG. 3, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor (AP), an electronic control unit (ECU), a graphical processing unit, and a memory control processor. As another example, the memory 130 may be configured by a RAM, a DRAM, a ROM, a flash memory, a volatile memory, a non-volatile memory, and/or a combination thereof.

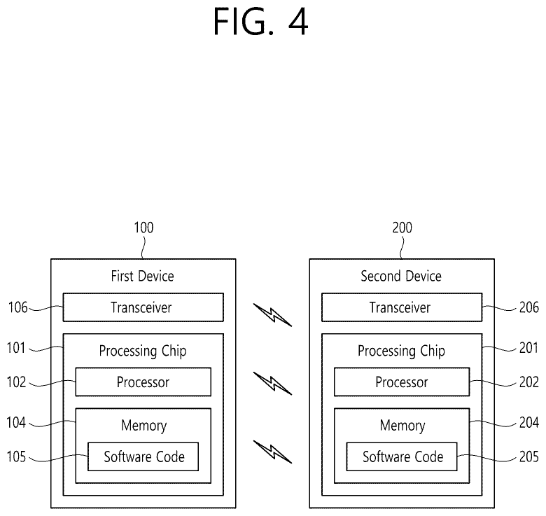

FIG. 4 shows another example of wireless devices to which implementations of the present disclosure is applied.

Referring to FIG. 4, wireless devices 100 and 200 may correspond to the wireless devices 100 and 200 of FIG. 2 and may be configured by various elements, components, units/portions, and/or modules.

The first wireless device 100 may include at least one transceiver, such as a transceiver 106, and at least one processing chip, such as a processing chip 101. The processing chip 101 may include at least one processor, such a processor 102, and at least one memory, such as a memory 104. The memory 104 may be operably connectable to the processor 102. The memory 104 may store various types of information and/or instructions. The memory 104 may store a software code 105 which implements instructions that, when executed by the processor 102, perform the descriptions, functions, procedures, suggestions, methods and/or operational flowcharts disclosed in the present disclosure. For example, the software code 105 may implement instructions that, when executed by the processor 102, perform the descriptions, functions, procedures, suggestions, methods and/or operational flowcharts disclosed in the present disclosure. For example, the software code 105 may control the processor 102 to perform one or more protocols. For example, the software code 105 may control the processor 102 may perform one or more layers of the radio interface protocol.

The second wireless device 200 may include at least one transceiver, such as a transceiver 206, and at least one processing chip, such as a processing chip 201. The processing chip 201 may include at least one processor, such a processor 202, and at least one memory, such as a memory 204. The memory 204 may be operably connectable to the processor 202. The memory 204 may store various types of information and/or instructions. The memory 204 may store a software code 205 which implements instructions that, when executed by the processor 202, perform the descriptions, functions, procedures, suggestions, methods and/or operational flowcharts disclosed in the present disclosure. For example, the software code 205 may implement instructions that, when executed by the processor 202, perform the descriptions, functions, procedures, suggestions, methods and/or operational flowcharts disclosed in the present disclosure. For example, the software code 205 may control the processor 202 to perform one or more protocols. For example, the software code 205 may control the processor 202 may perform one or more layers of the radio interface protocol.

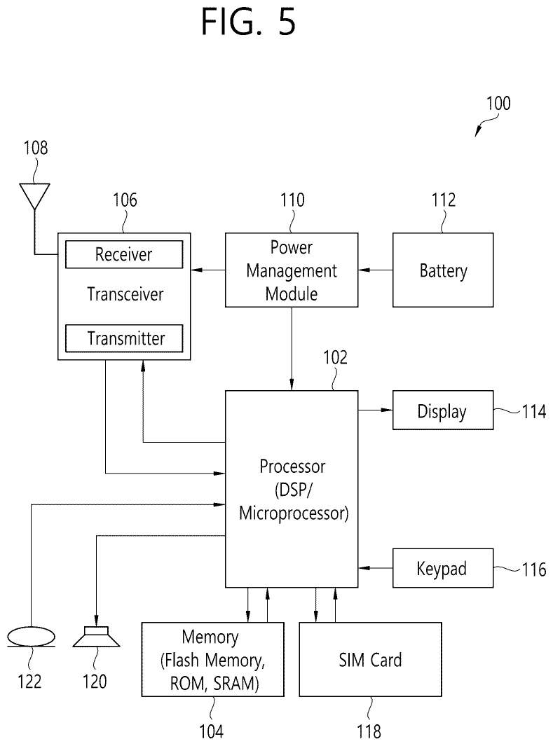

FIG. 5 shows an example of UE to which implementations of the present disclosure is applied.

Referring to FIG. 5, a UE 100 may correspond to the first wireless device 100 of FIG. 2 and/or the first wireless device 100 of FIG. 4.

A UE 100 includes a processor 102, a memory 104, a transceiver 106, one or more antennas 108, a power management module 110, a battery 1112, a display 114, a keypad 116, a subscriber identification module (SIM) card 118, a speaker 120, and a microphone 122.

The processor 102 may be configured to implement the descriptions, functions, procedures, suggestions, methods and/or operational flowcharts disclosed in the present disclosure. The processor 102 may be configured to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of a digital signal processor (DSP), a central processing unit (CPU), a graphics processing unit (GPU), a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 110 manages power for the processor 102 and/or the transceiver 106. The battery 112 supplies power to the power management module 110.

The display 114 outputs results processed by the processor 102. The keypad 116 receives inputs to be used by the processor 102. The keypad 16 may be shown on the display 114.

The SIM card 118 is an integrated circuit that is intended to securely store the international mobile subscriber identity (IMSI) number and its related key, which are used to identify and authenticate subscribers on mobile telephony devices (such as mobile phones and computers). It is also possible to store contact information on many SIM cards.

The speaker 120 outputs sound-related results processed by the processor 102. The microphone 122 receives sound-related inputs to be used by the processor 102.

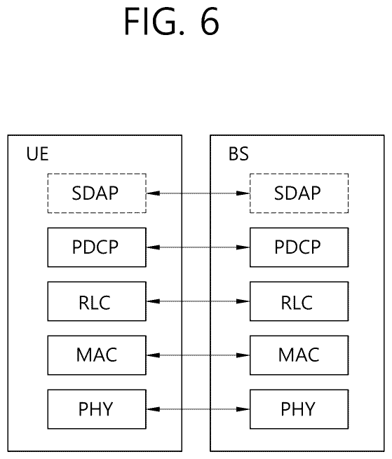

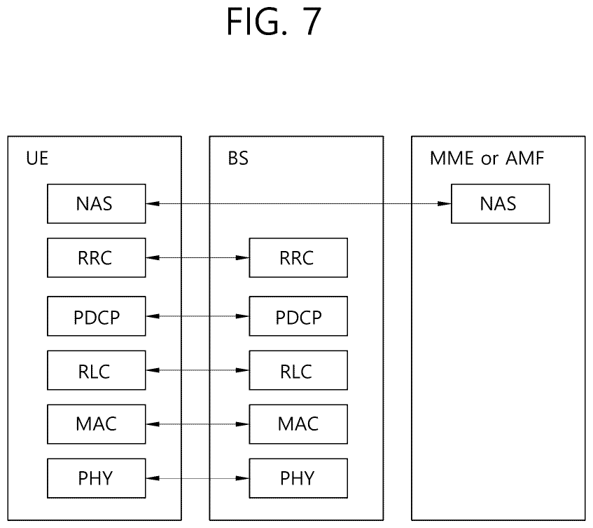

FIGS. 6 and 7 show an example of protocol stacks in a 3GPP based wireless communication system to which implementations of the present disclosure is applied.

In particular, FIG. 6 illustrates an example of a radio interface user plane protocol stack between a UE and a BS and FIG. 7 illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 6, the user plane protocol stack may be divided into Layer 1 (i.e., a PHY layer) and Layer 2. Referring to FIG. 7, the control plane protocol stack may be divided into Layer 1 (i.e., a PHY layer), Layer 2, Layer 3 (e.g., an RRC layer), and a non-access stratum (NAS) layer. Layer 1, Layer 2 and Layer 3 are referred to as an access stratum (AS).

In the 3GPP LTE system, the Layer 2 is split into the following sublayers: MAC, RLC, and PDCP. In the 3GPP NR system, the Layer 2 is split into the following sublayers: MAC, RLC, PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network quality of service (QOS) flows.

In the 3GPP NR system, the main services and functions of the MAC sublayer include: mapping between logical channels and transport channels; multiplexing/de-multiplexing of MAC SDUs belonging to one or different logical channels into/from transport blocks (TB) delivered to/from the physical layer on transport channels; scheduling information reporting; error correction through hybrid automatic repeat request (HARQ) (one HARQ entity per cell in case of carrier aggregation (CA)); priority handling between UEs by means of dynamic scheduling; priority handling between logical channels of one UE by means of logical channel prioritization; padding. A single MAC entity may support multiple numerologies, transmission timings and cells. Mapping restrictions in logical channel prioritization control which numerology (ies), cell(s), and transmission timing(s) a logical channel can use.

Different kinds of data transfer services are offered by MAC. To accommodate different kinds of data transfer services, multiple types of logical channels are defined, i.e., each supporting transfer of a particular type of information. Each logical channel type is defined by what type of information is transferred. Logical channels are classified into two groups: control channels and traffic channels. Control channels are used for the transfer of control plane information only, and traffic channels are used for the transfer of user plane information only. Broadcast control channel (BCCH) is a downlink logical channel for broadcasting system control information, paging control channel (PCCH) is a downlink logical channel that transfers paging information, system information change notifications and indications of ongoing public warning service (PWS) broadcasts, common control channel (CCCH) is a logical channel for transmitting control information between UEs and network and used for UEs having no RRC connection with the network, and dedicated control channel (DCCH) is a point-to-point bi-directional logical channel that transmits dedicated control information between a UE and the network and used by UEs having an RRC connection. Dedicated traffic channel (DTCH) is a point-to-point logical channel, dedicated to one UE, for the transfer of user information. A DTCH can exist in both uplink and downlink. In downlink, the following connections between logical channels and transport channels exist: BCCH can be mapped to broadcast channel (BCH); BCCH can be mapped to downlink shared channel (DL-SCH); PCCH can be mapped to paging channel (PCH); CCCH can be mapped to DL-SCH; DCCH can be mapped to DL-SCH; and DTCH can be mapped to DL-SCH. In uplink, the following connections between logical channels and transport channels exist: CCCH can be mapped to uplink shared channel (UL-SCH); DCCH can be mapped to UL-SCH; and DTCH can be mapped to UL-SCH.

The RLC sublayer supports three transmission modes: transparent mode (TM), unacknowledged mode (UM), and acknowledged node (AM). The RLC configuration is per logical channel with no dependency on numerologies and/or transmission durations. In the 3GPP NR system, the main services and functions of the RLC sublayer depend on the transmission mode and include: transfer of upper layer PDUs; sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; protocol error detection (AM only).

In the 3GPP NR system, the main services and functions of the PDCP sublayer for the user plane include: sequence numbering; header compression and decompression using robust header compression (ROHC); transfer of user data; reordering and duplicate detection; in-order delivery; PDCP PDU routing (in case of split bearers); retransmission of PDCP SDUs; ciphering, deciphering and integrity protection; PDCP SDU discard; PDCP re-establishment and data recovery for RLC AM; PDCP status reporting for RLC AM; duplication of PDCP PDUs and duplicate discard indication to lower layers. The main services and functions of the PDCP sublayer for the control plane include: sequence numbering; ciphering, deciphering and integrity protection; transfer of control plane data; reordering and duplicate detection; in-order delivery; duplication of PDCP PDUs and duplicate discard indication to lower layers.

In the 3GPP NR system, the main services and functions of SDAP include: mapping between a QoS flow and a data radio bearer; marking QoS flow ID (QFI) in both DL and UL packets. A single protocol entity of SDAP is configured for each individual PDU session.

In the 3GPP NR system, the main services and functions of the RRC sublayer include: broadcast of system information related to AS and NAS; paging initiated by 5GC or NG-RAN; establishment, maintenance and release of an RRC connection between the UE and NG-RAN; security functions including key management; establishment, configuration, maintenance and release of signaling radio bearers (SRBs) and data radio bearers (DRBs); mobility functions (including: handover and context transfer, UE cell selection and reselection and control of cell selection and reselection, inter-RAT mobility); QoS management functions; UE measurement reporting and control of the reporting; detection of and recovery from radio link failure; NAS message transfer to/from NAS from/to UE.

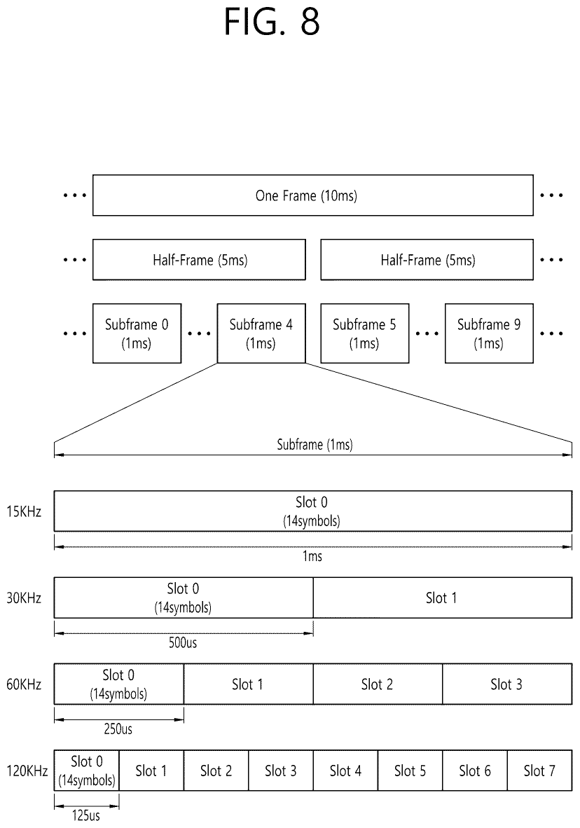

FIG. 8 shows a frame structure in a 3GPP based wireless communication system to which implementations of the present disclosure is applied.

The frame structure shown in FIG. 8 is purely exemplary and the number of subframes, the number of slots, and/or the number of symbols in a frame may be variously changed. In the 3GPP based wireless communication system, OFDM numerologies (e.g., subcarrier spacing (SCS), transmission time interval (TTI) duration) may be differently configured between a plurality of cells aggregated for one UE. For example, if a UE is configured with different SCSs for cells aggregated for the cell, an (absolute time) duration of a time resource (e.g., a subframe, a slot, or a TTI) including the same number of symbols may be different among the aggregated cells. Herein, symbols may include OFDM symbols (or CP-OFDM symbols), SC-FDMA symbols (or discrete Fourier transform-spread-OFDM (DFT-s-OFDM) symbols).

Referring to FIG. 8, downlink and uplink transmissions are organized into frames. Each frame has T_{f}=10 ms duration. Each frame is divided into two half-frames, where each of the half-frames has 5 ms duration. Each half-frame consists of 5 subframes, where the duration T_{sf} per subframe is 1 ms. Each subframe is divided into slots and the number of slots in a subframe depends on a subcarrier spacing. Each slot includes 14 or 12 OFDM symbols based on a cyclic prefix (CP). In a normal CP, each slot includes 14 OFDM symbols and, in an extended CP, each slot includes 12 OFDM symbols. The numerology is based on exponentially scalable subcarrier spacing Δf=2″*15 kHz.

Table 1 shows the number of OFDM symbols per slot N^{slot}_{symb}, the number of slots per frame N^{frame,u}ₛₗₒₜ, and the number of slots per subframe N^{subframe,u}ₛₗₒₜ for the normal CP, according to the subcarrier spacing Δf=2^{u}*15 kHz.

TABLE 1

| u | N_{symb}^{slot} | Nₛₗₒₜ^{frame,u} | Nₛₗₒₜ^{subframe,u} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 2 shows the number of OFDM symbols per slot N^{slot}_{symb}, the number of slots per frame N^{frame,u}ₛₗₒₜ, and the number of slots per subframe N^{subframe,u}ₛₗₒₜ for the extended CP, according to the subcarrier spacing Δf=2^{u}*15 kHz.

TABLE 2

| u | N_{symb}^{slot} | Nₛₗₒₜ^{frame,u} | Nₛₗₒₜ^{subframe,u} |
|---|---|---|---|
| 2 | 12 | 40 | 4 |

A slot includes plural symbols (e.g., 14 or 12 symbols) in the time domain. For each numerology (e.g., subcarrier spacing) and carrier, a resource grid of N^{size,u}_{grid,x}*N^{RB}_{sc} subcarriers and/subframe,u symb OFDM symbols is defined, starting at common resource block (CRB) N^{start,u}_{grid} indicated by higher-layer signaling (e.g., RRC signaling), where N^{size,u}_{grid,x} is the number of resource blocks (RBs) in the resource grid and the subscript x is DL for downlink and UL for uplink. N^{RB}_{sc} is the number of subcarriers per RB. In the 3GPP based wireless communication system, N^{RB}_{sc} is 12 generally. There is one resource grid for a given antenna port p, subcarrier spacing configuration u, and transmission direction (DL or UL). The carrier bandwidth N^{size,u}_{grid} for subcarrier spacing configuration u is given by the higher-layer parameter (e.g., RRC parameter). Each element in the resource grid for the antenna port p and the subcarrier spacing configuration u is referred to as a resource element (RE) and one complex symbol may be mapped to each RE. Each RE in the resource grid is uniquely identified by an index k in the frequency domain and an index/representing a symbol location relative to a reference point in the time domain. In the 3GPP based wireless communication system, an RB is defined by 12 consecutive subcarriers in the frequency domain.

In the 3GPP NR system, RBs are classified into CRBs and physical resource blocks (PRBs). CRBs are numbered from 0 and upwards in the frequency domain for subcarrier spacing configuration u. The center of subcarrier 0 of CRB 0 for subcarrier spacing configuration u coincides with ‘point A’ which serves as a common reference point for resource block grids. In the 3GPP NR system, PRBs are defined within a bandwidth part (BWP) and numbered from 0 to N^{size}_{BWP,i}−1, where i is the number of the bandwidth part. The relation between the physical resource block n_{PRB} in the bandwidth part i and the common resource block n_{CRB} is as follows: n_{PRB}=n_{CRB}+N^{size}_{BWP,i}, where N^{size}_{BWP,i} is the common resource block where bandwidth part starts relative to CRB 0. The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

The NR frequency band may be defined as two types of frequency range, i.e., FR1 and FR2. The numerical value of the frequency range may be changed. For example, the frequency ranges of the two types (FR1 and FR2) may be as shown in Table 3 below. For ease of explanation, in the frequency ranges used in the NR system, FR1 may mean “sub 6 GHz range”, FR2 may mean “above 6 GHz range,” and may be referred to as millimeter wave (mmW).

TABLE 3

| Frequency Range | Corresponding frequency | Subcarrier |
|---|---|---|
| designation | range | Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system may be changed. For example, FR1 may include a frequency band of 410 MHz to 7125 MHz as shown in Table 4 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 4

| Frequency Range | Corresponding frequency | |
|---|---|---|
| designation | range | Subcarrier Spacing |
| FR1 | 410 MHz-7125 MHz | 15, 30, 60 kHz |
| FR2 | 24250 MHz-52600 MHz | 60, 120, 240 kHz |

In the present disclosure, the term “cell” may refer to a geographic area to which one or more nodes provide a communication system, or refer to radio resources. A “cell” as a geographic area may be understood as coverage within which a node can provide service using a carrier and a “cell” as radio resources (e.g., time-frequency resources) is associated with bandwidth which is a frequency range configured by the carrier. The “cell” associated with the radio resources is defined by a combination of downlink resources and uplink resources, for example, a combination of a DL component carrier (CC) and a UL CC. The cell may be configured by downlink resources only, or may be configured by downlink resources and uplink resources. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of radio resources used by the node. Accordingly, the term “cell” may be used to represent service coverage of the node sometimes, radio resources at other times, or a range that signals using the radio resources can reach with valid strength at other times.

In CA, two or more CCs are aggregated. A UE may simultaneously receive or transmit on one or multiple CCs depending on its capabilities. CA is supported for both contiguous and non-contiguous CCs. When CA is configured, the UE only has one RRC connection with the network. At RRC connection establishment/re-establishment/handover, one serving cell provides the NAS mobility information, and at RRC connection re-establishment/handover, one serving cell provides the security input. This cell is referred to as the primary cell (PCell). The PCell is a cell, operating on the primary frequency, in which the UE either performs the initial connection establishment procedure or initiates the connection re-establishment procedure. Depending on UE capabilities, secondary cells (SCells) can be configured to form together with the PCell a set of serving cells. An SCell is a cell providing additional radio resources on top of special cell (SpCell). The configured set of serving cells for a UE therefore always consists of one PCell and one or more SCells. For dual connectivity (DC) operation, the term SpCell refers to the PCell of the master cell group (MCG) or the primary SCell (PSCell) of the secondary cell group (SCG). An SpCell supports PUCCH transmission and contention-based random access, and is always activated. The MCG is a group of serving cells associated with a master node, comprised of the SpCell (PCell) and optionally one or more SCells. The SCG is the subset of serving cells associated with a secondary node, comprised of the PSCell and zero or more SCells, for a UE configured with DC. For a UE in RRC_CONNECTED not configured with CA/DC, there is only one serving cell comprised of the PCell. For a UE in RRC_CONNECTED configured with CA/DC, the term “serving cells” is used to denote the set of cells comprised of the SpCell(s) and all SCells. In DC, two MAC entities are configured in a UE: one for the MCG and one for the SCG.

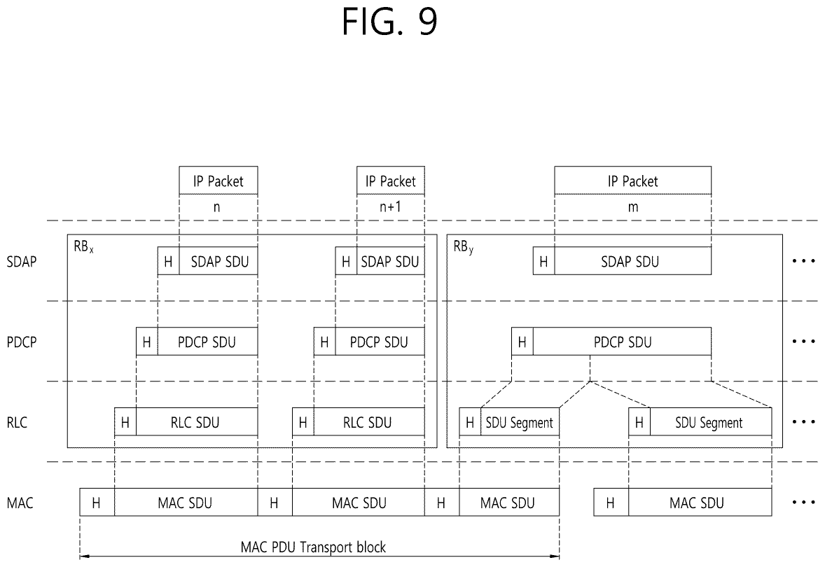

FIG. 9 shows a data flow example in the 3GPP NR system to which implementations of the present disclosure is applied.

Referring to FIG. 9, “RB” denotes a radio bearer, and “H” denotes a header. Radio bearers are categorized into two groups: DRBs for user plane data and SRBs for control plane data. The MAC PDU is transmitted/received using radio resources through the PHY layer to/from an external device. The MAC PDU arrives to the PHY layer in the form of a transport block.

In the PHY layer, the uplink transport channels UL-SCH and RACH are mapped to their physical channels PUSCH and PRACH, respectively, and the downlink transport channels DL-SCH, BCH and PCH are mapped to PDSCH, PBCH and PDSCH, respectively. In the PHY layer, uplink control information (UCI) is mapped to PUCCH, and downlink control information (DCI) is mapped to PDCCH. A MAC PDU related to UL-SCH is transmitted by a UE via a PUSCH based on an UL grant, and a MAC PDU related to DL-SCH is transmitted by a BS via a PDSCH based on a DL assignment.

Hereinafter, technical features related to RRC connection resume are described. Section 5.3.13 of 3GPP TS 38.331 v17.3.0 may be referred.

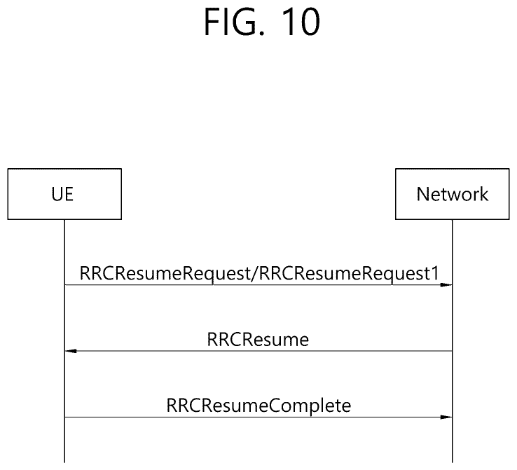

FIG. 10 shows an example of a successful RRC connection resume procedure.

UE transmits RRCResumeRequest and/or RRCResumeRequest1 to the network.

UE receives RRCResume from the network.

UE transmits RRCResumeComplete to the network.

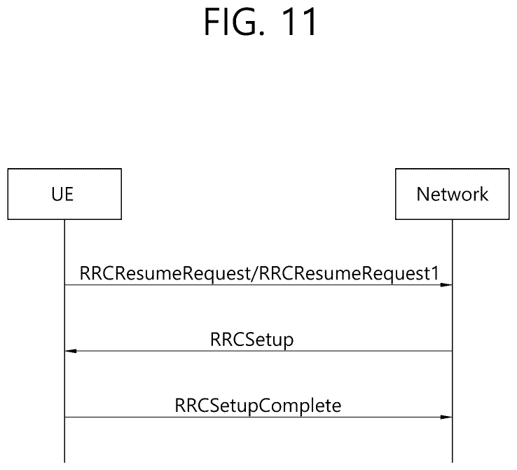

FIG. 11 shows an example of a successful RRC connection resume fallback to RRC connection establishment.

UE transmits RRCResumeRequest and/or RRCResumeRequest1 to the network.

UE receives RRCSetup from the network.

UE transmits RRCSetupComplete to the network.

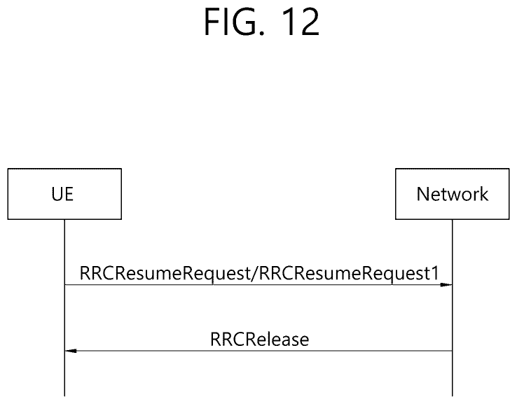

FIG. 12 shows an example of a successful RRC connection resume followed by network release.

UE transmits RRCResumeRequest and/or RRCResumeRequest1 to the network.

UE receives RRCRelease from the network.

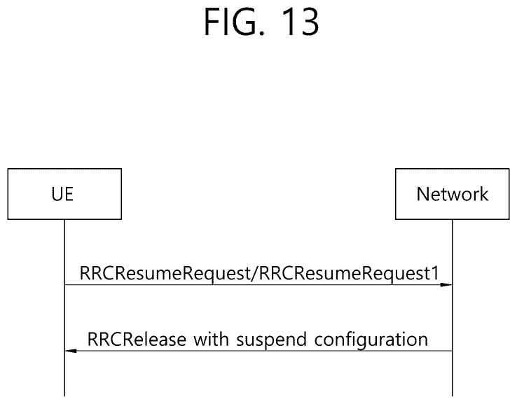

FIG. 13 shows an example of a successful RRC connection resume followed by network suspend.

UE transmits RRCResumeRequest and/or RRCResumeRequest1 to the network.

UE receives RRCRelease with suspend configuration from the network.

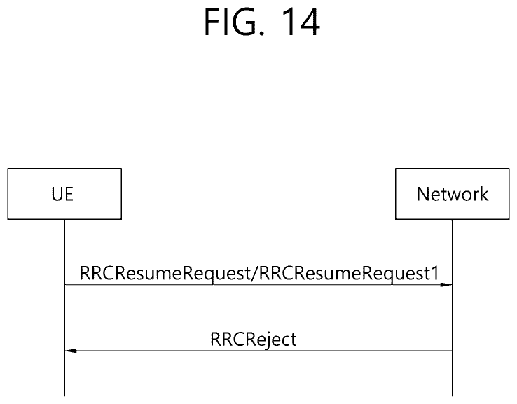

FIG. 14 shows an example of a network rejection for the RRC connection resume.

UE transmits RRCResumeRequest and/or RRCResumeRequest1 to the network.

UE receives RRCReject from the network.

The purpose of this procedure is to resume a suspended RRC connection, including resuming SRB(s), DRB(s) and multicast MRB(s) or perform an RNA update. This procedure is also used to initiate SDT in RRC_INACTIVE.
Conditions for resuming RRC Connection for NR sidelink communication/discovery/V2X sidelink communication

For NR sidelink communication/discovery an RRC connection is resumed only in the following cases:
1> if configured by upper layers to transmit NR sidelink communication/discovery and related data is available for transmission:
2> if the frequency on which the UE is configured to transmit NR sidelink communication is included in sl-FreqInfoList within SIB12 provided by the cell on which the UE camps; and if the valid version of SIB12 does not include sl-TxPoolSelectedNormal for the concerned frequency; or
2> if the frequency on which the UE is configured to transmit NR sidelink discovery is included in sl-FreqInfoList within SIB12 provided by the cell on which the UE camps; and if the valid version of SIB12 does not include sl-DiscTxPoolSelected or sl-TxPoolSelectedNormal for the concerned frequency;

For L2 U2N Relay UE in RRC_INACTIVE, an RRC connection establishment is resumed in the following cases:
1> if any message is received from the L2 U2N Remote UE via SL-RLC0 or SL-RLC1;

For V2X sidelink communication an RRC connection resume is initiated only when the conditions specified for V2X sidelink communication are met.

Upper layers initiate an RRC connection resume (except if the RRC connection resume is initiated at the L2 U2N Relay UE upon reception of a message from a L2 U2N Remote UE via SL-RLC0 or SL-RLC1). The interaction with NAS is left to UE implementation.
Conditions for initiating SDT

A UE in RRC_INACTIVE initiates the resume procedure for SDT when all of the following conditions are fulfilled:
1> the upper layers request resumption of RRC connection; and
1> SIB1 includes sdt-ConfigCommon; and
1> sdt-Config is configured; and
1> all the pending data in UL is mapped to the radio bearers configured for SDT; and
1> lower layers indicate that conditions for initiating SDT are fulfilled.

Hereinafter, technical features related to Conditional Reconfiguration are described. Section 5.3.5.13 of 3GPP TS 38.331 v17.3.0 may be referred.

The network configures the UE with one or more candidate target SpCells in the conditional reconfiguration. The UE evaluates the condition of each configured candidate target SpCell. The UE applies the conditional reconfiguration associated with one of the target SpCells which fulfils associated execution condition. The network provides the configuration parameters for the target SpCell in the ConditionalReconfiguration IE.

In NR-DC, the UE may receive two independent conditionalReconfiguration:
a conditionalReconfiguration associated with MCG, that is included in the RRCReconfiguration message received via SRB1; and
a conditionalReconfiguration, associated with SCG, that is included in the RRCReconfiguration message received via SRB3, or, alternatively, included within a RRCReconfiguration message embedded in a RRCReconfiguration message received via SRB1.

In this case:
the UE maintains two independent VarConditionalReconfig, one associated with each conditionalReconfiguration;
the UE independently performs all the procedures for each conditionalReconfiguration and the associated VarConditionalReconfig, unless explicitly stated otherwise;
the UE performs the procedures in clause 5.5 for the VarConditionalReconfig associated with the same cell group like the measConfig.

The UE performs the following actions based on a received ConditionalReconfiguration IE:
1> if the ConditionalReconfiguration contains the condReconfigToRemoveList:
2> perform conditional reconfiguration removal procedure;
1> if the ConditionalReconfiguration contains the condReconfigToAddModList:
2> perform conditional reconfiguration addition/modification;
Conditional reconfiguration removal

The UE shall:
1> for each condReconfigId value included in the condReconfigToRemoveList that is part of the current UE conditional reconfiguration in VarConditionalReconfig:
2> remove the entry with the matching condReconfigId from the VarConditionalReconfig;
Conditional reconfiguration addition/modification

For each condReconfigId received in the condReconfigToAddModList IE the UE shall:
1> if an entry with the matching condReconfigId exists in the condReconfigToAddModList within the VarConditionalReconfig:
2> if the entry in condReconfigToAddModList includes an condExecutionCond or condExecutionCondSCG;
3> replace condExecutionCond or condExecutionCondSCG within the VarConditionalReconfig with the value received for this condReconfigId;
2> if the entry in condReconfigToAddModList includes an condRRCReconfig;
3> replace condRRCReconfig within the VarConditionalReconfig with the value received for this condReconfigId;
1> else:
2> add a new entry for this condReconfigId within the VarConditionalReconfig;
1> perform conditional reconfiguration evaluation;
Conditional reconfiguration evaluation

The UE shall:
1> for each condReconfigId within the VarConditionalReconfig:
2> if the RRCReconfiguration within condRRCReconfig includes the masterCellGroup including the reconfigurationWithSync:
3> consider the cell which has a physical cell identity matching the value indicated in the ServingCellConfigCommon included in the reconfigurationWithSync within the masterCellGroup in the received condRRCReconfig to be applicable cell;
2> else if the RRCReconfiguration within condRRCReconfig includes the secondaryCellGroup including the reconfiguration WithSync:
3> consider the cell which has a physical cell identity matching the value indicated in the ServingCellConfigCommon included in the reconfigurationWithSync within the secondaryCellGroup within the received condRRCReconfig to be applicable cell;
2> if condExecutionCondSCG is configured:
3> in the remainder of the procedure, consider each measId indicated in the condExecutionCondSCG as a measId in the VarMeasConfig associated with the SCG measConfig;
2> if condExecutionCond is configured:
3> if it is configured via SRB3 or configured within nr-SCG or within nr-SecondaryCellGroupConfig via SRB1:
4> in the remainder of the procedure, consider each measId indicated in the condExecutionCond as a measId in the VarMeasConfig associated with the SCG measConfig;
3> else:
4> in the remainder of the procedure, consider each measId indicated in the condExecutionCond as a measId in the VarMeasConfig associated with the MCG measConfig;
2> for each measId included in the measIdList within VarMeasConfig indicated in the condExecutionCond or condExecutionCondSCG associated to condReconfigId:
3> if the condEventId is associated with condEventTI, and if the entry condition applicable for this event associated with the condReconfigId, i.e. the event corresponding with the condEventId(s) of the corresponding condTriggerConfig within VarConditionalReconfig, is fulfilled for the applicable cell; or
3> if the condEventId is associated with condEventDI, and if the entry conditions applicable for this event associated with the condReconfigId, i.e. the event corresponding with the condEventId(s) of the corresponding condTriggerConfig within VarConditionalReconfig, is fulfilled for the applicable cell during the corresponding timeToTrigger defined for this event within the VarConditionalReconfig; or
3> if the condEventId is associated with condEventA3, condEventA4 or condEventA5, and if the entry condition(s) applicable for this event associated with the condReconfigId, i.e. the event corresponding with the condEventId(s) of the corresponding condTriggerConfig within VarConditionalReconfig, is fulfilled for the applicable cells for all measurements after layer 3 filtering taken during the corresponding timeToTrigger defined for this event within the VarConditionalReconfig:
4> consider the event associated to that measId to be fulfilled;
3> if the measId for this event associated with the condReconfigld has been modified; or
3> if the condEventId is associated with condEventTI, and if the leaving condition applicable for this event associated with the condReconfigld, i.e. the event corresponding with the condEventId(s) of the corresponding condTriggerConfig within VarConditionalReconfig, is fulfilled for the applicable cell; or
3> if the condEventId is associated with condEventDI, and if the leaving condition(s) applicable for this event associated with the condReconfigId, i.e. the event corresponding with the condEventId(s) of the corresponding condTriggerConfig within VarConditionalReconfig, is fulfilled for the applicable cell during the corresponding timeToTrigger defined for this event within the VarConditionalReconfig; or
3> if the condEventId is associated with condEventA3, condEventA4 or condEventA5, and if the leaving condition(s) applicable for this event associated with the condReconfigId, i.e. the event corresponding with the condEventId(s) of the corresponding condTriggerConfig within VarConditionalReconfig, is fulfilled for the applicable cells for all measurements after layer 3 filtering taken during the corresponding timeToTrigger defined for this event within the VarConditionalReconfig:
4> consider the event associated to that measId to be not fulfilled;
2> if event(s) associated to all measId(s) within condTriggerConfig for a target candidate cell within the stored condRRCReconfig are fulfilled:
3> consider the target candidate cell within the stored condRRCReconfig, associated to that condReconfigId, as a triggered cell;
3> initiate the conditional reconfiguration execution;
Up to 2 MeasId can be configured for each condReconfigId. The conditional reconfiguration event of the 2 MeasId may have the same or different event conditions, triggering quantity, time to trigger, and triggering threshold.
Conditional reconfiguration evaluation of SN initiated inter-SN CPC for EN-DC The UE shall:
1> for each condReconfigurationId within the VarConditionalReconfiguration:
2> for each measId included in the measIdList within VarMeasConfig indicated in the CondReconfigExecCondSCG contained in the triggerConditionSN associated to the condReconfigurationId:
3> if the entry condition(s) applicable for the event associated with that measId, is fulfilled for the applicable cells for all measurements after layer 3 filtering taken during the corresponding timeToTrigger defined for this event associated with that measId:
4> consider this event to be fulfilled;
3> if the measId for this event has been modified; or
3> if the leaving condition(s) applicable for this event associated with that measId, is fulfilled for the applicable cells for all measurements after layer 3 filtering taken during the corresponding timeToTrigger defined for this event associated with that measId:
4> consider this event associated to that measId to be not fulfilled;
2> if trigger conditions for all events associated with the measId(s) indicated in the CondReconfigExecCondSCG contained in the triggerConditionSN, are fulfilled:
3> consider the target cell candidate within the RRCReconfiguration message contained in nr-SecondaryCellGroupConfig in the RRCConnectionReconfiguration message, contained in the stored condReconfigurationToApply, associated to that condReconfigurationId, as a triggered cell;
3> initiate the conditional reconfiguration execution;
Conditional reconfiguration execution

The UE shall:
1> if more than one triggered cell exists:
2> select one of the triggered cells as the selected cell for conditional reconfiguration execution;
1> else:
2> consider the triggered cell as the selected cell for conditional reconfiguration execution; 1> for the selected cell of conditional reconfiguration execution:
2> apply the stored condRRCReconfig of the selected cell and perform the actions;
If multiple NR cells are triggered in conditional reconfiguration execution, it is up to UE implementation which one to select, e.g. the UE considers beams and beam quality to select one of the triggered cells for execution.
SCG activation

Upon initiating the procedure, the UE shall:
1> if the UE is configured with an SCG after receiving the message for which this procedure is initiated:
2> if the UE was configured with a deactivated SCG before receiving the message

for which this procedure is initiated:
3> consider the SCG to be activated;
3> resume performing radio link monitoring on the SCG, if previously stopped;
3> indicate to lower layers to resume beam failure detection on the PSCell, if

previously stopped;
3> indicate to lower layers that the SCG is activated.
SCG deactivation

Upon initiating the procedure, the UE shall:
1> consider the SCG to be deactivated;
1> indicate to lower layers that the SCG is deactivated;
1> if bfd-and-RLM is configured to true:
2> perform radio link monitoring on the SCG;
2> indicate to lower layers to perform beam failure detection on the PSCell;
1> else:
2> stop radio link monitoring on the SCG;
2> indicate to lower layers to stop beam failure detection on the PSCell;
2> stop timer T310 for this cell group, if running;
2> stop timer T312 for this cell group, if running;
2> reset the counters N310 and N311;
1> if the UE was in RRC_CONNECTED and the SCG was activated before receiving the message for which this procedure is initiated:
2> if SRB3 was configured before the reception of the RRCReconfiguration or of the RRCConnectionReconfiguration and SRB3 is not to be released according to any RadioBearerConfig included in the RRCReconfiguration or in the RRCConnectionReconfiguration:
3> trigger the PDCP entity of SRB3 to perform SDU discard;
3> re-establish the RLC entity of SRB3.
SCG activation without SN message

Upon initiating the procedure, the UE shall:
1> if the SCG was deactivated before the reception of the RRCReconfiguration message or the E-UTRA RRCConnectionReconfiguration message for which the procedure invoking this clause is executed:
2> consider the SCG to be activated;
2> indicate to lower layers that the SCG is activated;
2> resume performing radio link monitoring on the SCG, if previously stopped;
2> indicate to lower layers to resume beam failure detection on the PSCell, if previously stopped;
2> if bfd-and-RLM was not configured to true before the reception of the RRCReconfiguration message or the E-UTRA RRCConnectionReconfiguration message for which the procedure invoking this clause is executed; or
2> if lower layers indicate that a Random Access procedure is needed for SCG activation:
3> initiate the Random Access procedure on the PSCell.

Hereinafter, technical features related to full configuration are described. Section 5.3.5.11 of 3GPP TS 37.340 v17.3.0 may be referred.

The UE shall:
1> release/clear all current dedicated radio configurations except for the following:
the MCG C-RNTI;
the AS security configurations associated with the master key;
the SRB1/SRB2 configurations and DRB/multicast MRB configurations as configured by radioBearerConfig or radioBearerConfig2.
Radio configuration is not just the resource configuration but includes other configurations like MeasConfig. Radio configuration also includes the RLC bearer configurations as configured by RLC-BearerConfig, PC5 Relay RLC channel as configured by SL-RLC-ChannelConfig, and Uu Relay RLC channel as configured by Uu-RelayRLC-ChannelConfig. In case NR-DC or NE-DC is configured, this also includes the entire NR or E-UTRA SCG configuration which are released according to the MR-DC release procedure.
For NR sidelink communication/discovery, the radio configuration includes the sidelink RRC configuration received from the network, but does not include the sidelink RRC reconfiguration and sidelink UE capability received from other UEs via PC5-RRC. In addition, the UE considers the new NR sidelink configurations as full configuration, in case of state transition and change of system information used for NR sidelink communication/discovery.
To establish the RLC bearer of SRB(s) after release due to fullConfig, the network can include the srb-Identity within srb-ToAddModList (i.e. the UE applies RLC default configuration) and/or provide rlc-Bearer ToAddModList of concerned SRB(s) explicitly.
the logged measurement configuration;
1> if the spCellConfig in the masterCellGroup includes the reconfigurationWithSync:
2> release/clear all current common radio configurations;
2> if sl-PathSwitchConfig was included in reconfigurationWithSync:
3> use the default values for timer T311;
2> else:
3> use the default values for timers T310, T311 and constants N310, N311;
1> else (full configuration after re-establishment or during RRC resume):
2> if the UE is acting as L2 U2N Remote UE:
3> use value for timer T311, as included in ue-TimersAndConstants received in SIB1
2> else:
3> use values for timers T301, T310, T311 and constants N310, N311, as included in ue-TimersAndConstants received in SIB1;
1> if no meas ConfigAppLayerId is included:
2> inform upper layers about the release of all application layer measurement configurations;
2> discard any received application layer measurement report from upper layers;
2> consider itself not to be configured to send application layer measurement report.
1> if the UE is acting as L2 U2N Remote UE at the target side during reconfiguration with sync, or after re-establishment, or during RRC resume:
2> apply the default configuration of SL-RLC1 and associate it with the SRB1;
1> else:
2> apply the default L1 parameter values as specified in corresponding physical layer specifications except for the following:
parameters for which values are provided in SIB1;
2> apply the default MAC Cell Group configuration;
2> for each srb-Identity value included in the srb-ToAddModList (SRB reconfiguration):
3> establish an RLC entity for the corresponding SRB;
3> apply the default SRB configuration defined in 9.2.1 for the corresponding SRB;
This is to get the SRBs (SRB1 and SRB2 for reconfiguration with sync and SRB2 for resume and reconfiguration after re-establishment) to a known state from which the reconfiguration message can do further configuration.
1> for each pdu-Session that is part of the current UE configuration:
2> release the SDAP entity;
2> release each DRB associated to the pdu-Session;
This will retain the pdu-Session but remove the DRBs including drb-identity of these bearers from the current UE configuration. Setup of the DRBs within the AS is described in clause 5.3.5.6.5 using the new configuration. The pdu-Session acts as the anchor for associating the released and re-setup DRB. In the AS the DRB re-setup is equivalent with a new DRB setup (including new PDCP and logical channel configurations).
1> for each mbs-SessionId that is part of the current UE configuration and associated to a multicast MRB:
2> release the SDAP entity;
2> release each multicast MRB associated to the mbs-SessionId;
This will retain the mbs-SessionId but remove the multicast MRBs including mrb-identity of these bearers from the current UE configuration. Setup of the multicast MRBs within the AS is described using the new configuration. The mbs-SessionId acts as the anchor for associating the released and re-setup multicast MRB. In the AS the multicast MRB re-setup is equivalent with a new multicast MRB setup (including new PDCP and logical channel configurations).
1> for each pdu-Session that is part of the current UE configuration but not added with same pdu-Session in the drb-ToAddModList:
2> if the procedure was triggered due to reconfiguration with sync:
3> indicate the release of the user plane resources for the pdu-Session to upper layers after successful reconfiguration with sync;
2> else:
3> indicate the release of the user plane resources for the pdu-Session to upper layers immediately;
1> for each mbs-SessionId that is part of the current UE configuration but not added with the same mbs-SessionId in the mrb-ToAddModList:
2> if the procedure was triggered due to reconfiguration with sync:
3> indicate the release of the user plane resources for the mbs-SessionId to upper layers after successful reconfiguration with sync;
2> else:
3> indicate the release of the user plane resources for the mbs-SessionId to upper layers immediately.

Hereinafter, technical features related to SN initiated conditional SN Change are described. Section 5.3.5.11 of 3GPP TS 37.340 v17.3.0 may be referred.

The SN initiated conditional SN change procedure is used for CPC configuration and CPC execution.

The SN initiated conditional SN change procedure may also be initiated by the source SN, to modify the existing CPC configuration, or to trigger the release of the candidate SN by cancellation of all the prepared PSCells at the candidate SN and releasing the CPC related UE context at the candidate SN.

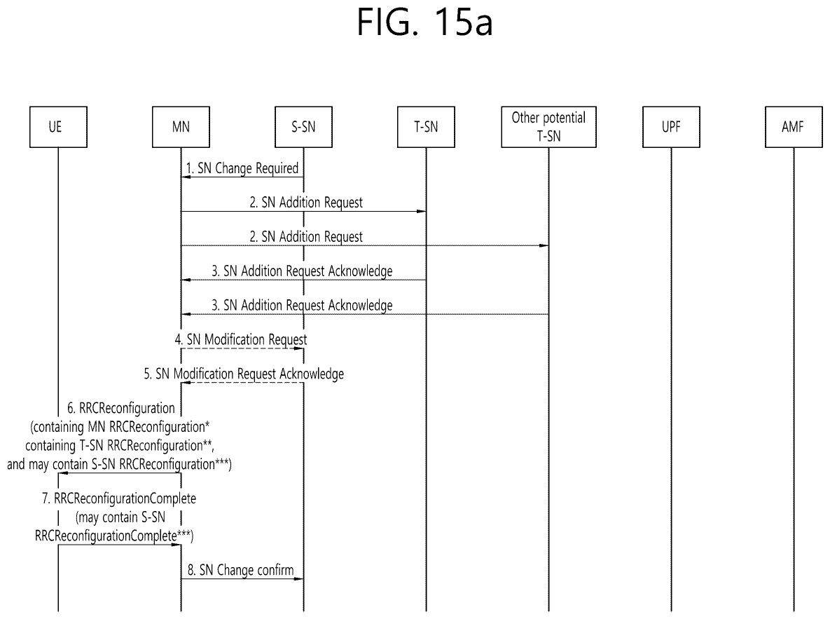

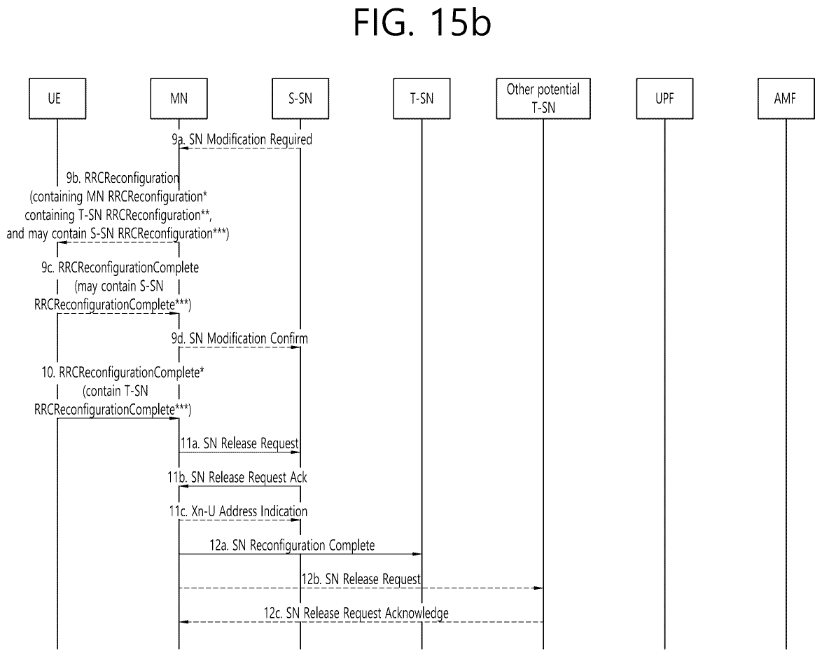

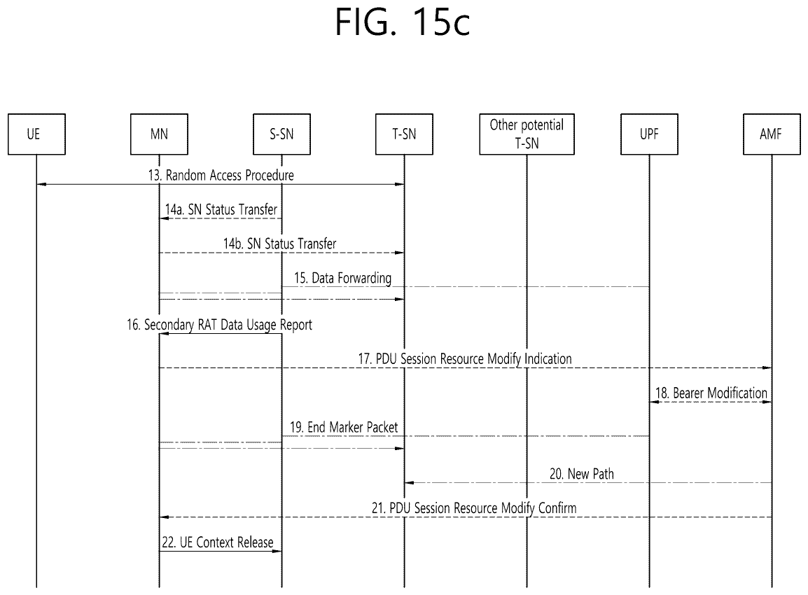

FIGS. 15a, 15b, and 15c show an example of a conditional SN change procedure initiated by SN.

In particular, FIGS. 15a, 15b, and 15c illustrate an example of signalling flow for the conditional SN Change initiated by the SN:
1. The source SN initiates the conditional SN change procedure by sending the SN Change Required message, which contains a CPC initiation indication. The message also contains candidate node ID(s) and may include the SCG configuration (to support delta configuration), and contains the measurements results which may include cells that are not CPC candidates. The message also includes a list of proposed PSCell candidates recommended by the source SN, including execution conditions, the upper limit for the number of PSCells that can be prepared by each candidate SN, and may also include the SCG measurement configurations for CPC (e.g. measurement ID(s) to be used for CPC).
2/3. The MN requests each candidate SN(s) to allocate resources for the UE by means of the SN Addition procedure(s), indicating the request is for CPAC, and the measurements results which may include cells that are not CPC candidates received from the source SN to the candidate SN, and indicating a list of proposed PSCell candidates received from the source SN, but not including execution conditions. Within the list of PSCells suggested by the source SN, the candidate SN decides the list of PSCell(s) to prepare (considering the maximum number indicated by the MN) and, for each prepared PSCell, the candidate SN decides SCG SCells and provides the new corresponding SCG radio resource configuration to the MN in an NR RRCReconfiguration** message contained in the SgNB Addition Request Acknowledge message. If data forwarding is needed, the candidate SN provides data forwarding addresses to the MN. The candidate SN includes the indication of full or delta RRC configuration, and the list of prepared PSCell IDs to the MN. The candidate SN can either accept or reject each of the candidate cells suggested by the source SN, i.e., it cannot configure any alternative candidates.
4/5. The MN may indicate the candidate PSCells accepted by each candidate SN to the source SN via SN Modification Request message before it configures the UE, e.g., when not all candidate PSCells were accepted by the candidate SN(s). If the MN does not send such indication, step 4 and 5 are skipped. If requested, the source SN sends an SN Modification Request Acknowledge message and if needed, provides an updated measurement configurations and/or the execution conditions to the MN.
6. The MN sends to the UE an RRCReconfiguration message including the CPC configuration, i.e. a list of RRCReconfiguration* messages and associated execution conditions, in which each RRCReconfiguration* message contains the SCG configuration in the RRCReconfiguration** message received from the candidate SN in step 3 and possibly an MCG configuration. Besides, the RRCReconfiguration message can also include an updated MCG configuration, as well as the NR RRCReconfiguration*** message generated by the source SN, e.g., to configure the required conditional measurements.
7. The UE applies the RRCReconfiguration message received in step 6, stores the CPC configuration and replies to the MN with an RRCReconfigurationComplete message, which can include an NR RRCReconfigurationComplete*** message. In case the UE is unable to comply with (part of) the configuration included in the RRCReconfiguration message, it performs the reconfiguration failure procedure.
8. If an SN RRC response message is included, the MN informs the source SN with the SN RRCReconfigurationComplete*** message via SN Change Confirm message. If step 4 and 5 are skipped, the MN will indicate the candidate PSCells accepted by each candidate SN to the source SN in the SN Change Confirm message.

The MN sends the SN Change Confirm message towards the source SN to indicate that CPC is prepared, and in such case the source SN continues providing user data to the UE. If early data forwarding is applied, the MN informs the source SN the data forwarding addresses as received from the candidate SN(s), the source SN, if applicable, together with the Early Status Transfer procedure, starts early data forwarding. The PDCP SDU forwarding may take place during early data forwarding. In case multiple candidate SNs are prepared, the MN includes a list of Target SN ID and list of data forwarding addresses to the source SN.
The Xn-U Address Indication procedure may further be invoked to indicate to the source SN to stop already initiated early data forwarding for some PDCP SDUs if they are no longer subject to data forwarding due to the modification or cancellation of the prepared conditional PSCell change.
9a-9d. The source SN may send the SN Modification Required message to trigger an update of CPC execution condition and/or corresponding SCG measurement configuration for CPC. In such case in step 9b, the MN reconfigures the UE and in step 9c the UE responds with RRCReconfigurationComplete, similarly as in steps 6 and 7.
10. The UE starts evaluating the execution conditions. If the execution condition of one candidate PSCell is satisfied, the UE applies RRCReconfiguration* message corresponding to the selected candidate PSCell, and sends an RRCReconfigurationComplete* message, including an RRCReconfigurationComplete** message for the selected candidate PSCell, and information enabling the MN to identify the SN of the selected candidate PSCell.
11a-11c. The MN triggers the MN initiated SN Release procedure to inform the source SN to stop providing user data to the UE, and triggers the Xn-U Address Indication procedure to inform the source SN the address of the SN of the selected candidate PSCell and if applicable, starts late data forwarding.
12a-12c. If the RRC connection reconfiguration procedure was successful, the MN informs the SN of the selected candidate PSCell via SN Reconfiguration Complete message, including the SN RRCReconfigurationComplete** message. The MN sends the SN Release Request message(s) to cancel CPC in the other candidate SN(s), if configured. The other candidate SN(s) acknowledges the release request.
13. The UE synchronizes to the PSCell indicated in the RRCReconfiguration* message applied in step 10.
14. If PDCP termination point is changed for bearers using RLC AM, the source SN sends the SN Status Transfer message, which the MN sends then to the SN of the selected candidate PSCell, if needed.
15. If applicable, data forwarding from the source SN takes place. It may be initiated as early as the source SN receives the data forwarding address related information from the MN.
16. The source SN sends the Secondary RAT Data Usage Report message to the MN and includes the data volumes delivered to and received from the UE as described in clause 10.11.2.
The order the SN sends the Secondary RAT Data Usage Report message and performs data forwarding with MN/target SN is not defined. The SN may send the report when the transmission of the related QoS flow is stopped.
17-21. If applicable, a PDU Session path update procedure is triggered by the MN.
22. Upon reception of the UE Context Release message, the source SN releases radio and C-plane related resources associated to the UE context. Any ongoing data forwarding may continue.

Hereinafter, technical features related to cell re-selection are described. Section 5.2.4 of 3GPP TS 38.304 v17.3.0 may be referred.
Reselection priorities handling

Absolute priorities of different NR frequencies or inter-RAT frequencies may be provided to the UE in the system information, in the RRCRelease message, or by inheriting from another RAT at inter-RAT cell (re) selection. In the case of system information, an NR frequency or inter-RAT frequency may be listed without providing a priority (i.e. the field cellReselectionPriority is absent for that frequency). If any fields with cellReselectionPriority or nsag-CellReselectionPriority are provided in dedicated signalling, the UE shall ignore any fields with cellReselectionPriority and nsag-CellReselectionPriority provided in system information.

When UE is in camped normally state, if it supports slice-based cell reselection and has received the network slice(s) and NSAG information from NAS to be used for cell reselection, UE shall derive reselection priorities.

If UE is in camped on any cell state, UE shall only apply the priorities provided by system information from current cell, and the UE preserves priorities provided by dedicated signalling and deprioritisationReq received in RRCRelease unless specified otherwise. When the UE in camped normally state, has only dedicated priorities other than for the current frequency, the UE shall consider the current frequency to be the lowest priority frequency (i.e. lower than any of the network configured values). When the HSDN capable UE is in High-mobility state, the UE shall always consider the HSDN cells to be the highest priority (i.e., higher than any other network configured priorities). When the HSDN capable UE is not in High-mobility state, the UE shall always consider HSDN cells to be the lowest priority (i.e., lower than any other network configured priorities). If the UE is configured to perform both NR sidelink communication and V2X sidelink communication, the UE may consider the frequency providing both NR sidelink communication configuration and V2X sidelink communication configuration to be the highest priority. If the UE is configured to perform NR sidelink communication and not perform V2X communication, the UE may consider the frequency providing NR sidelink communication configuration to be the highest priority. If the UE is configured to perform V2X sidelink communication and not perform NR sidelink communication, the UE may consider the frequency providing V2X sidelink communication configuration to be the highest priority.

For example, the frequency only providing the anchor frequency configuration should not be prioritized for V2X service during cell reselection.

For example, when UE is configured to perform NR sidelink communication or V2X sidelink communication performs cell reselection, it may consider the frequencies providing the intra-carrier and inter-carrier configuration have equal priority in cell reselection.

For example, the prioritization among the frequencies which UE considers to be the highest priority frequency is left to UE implementation unless otherwise stated.

For example, the UE is configured to perform V2X sidelink communication or NR sidelink communication, if it has the capability and is authorized for the corresponding sidelink operation.

For example, when UE is configured to perform both NR sidelink communication and V2X sidelink communication, but cannot find a frequency which can provide both NR sidelink communication configuration and V2X sidelink communication configuration, UE may consider the frequency providing either NR sidelink communication configuration or V2X sidelink communication configuration to be the highest priority.

The UE shall only perform cell reselection evaluation for NR frequencies and inter-RAT frequencies that are given in system information and for which the UE has a priority provided.

If the MBS broadcast capable UE is receiving or interested to receive an MBS broadcast service(s) and can only receive this MBS broadcast service(s) by camping on a frequency on which it is provided, the UE may consider that frequency to be the highest priority during the MBS broadcast session as specified in TS 38.300 [2] as long as the two following conditions are fulfilled:
1) SIB1 scheduling information of the cell reselected by the UE due to frequency prioritization for MBS contains SIB20;
2) Either:
One or more MBS FSAI(s) of that frequency is indicated in SIB21 of the serving cell and the same MBS FSAI(s) is also indicated for this MBS broadcast service in MBS User Service Description (USD), or
SIB21 is not provided in the serving cell and that frequency is included in the USD of this service, or
SIB21 is provided in the serving cell but does not provide the frequency mapping for the concerned service, and that frequency is included in the USD of this service.

For example, it is up to UE implementation which frequency to select, when the USD provides multiple frequencies for the service the UE is interested in.

If the MBS broadcast capable UE is receiving or interested to receive an MBS broadcast service, the UE may consider cell reselection candidate frequencies at which it cannot receive the MBS broadcast service to be of the lowest priority during the MBS broadcast session, as long as SIB1 scheduling information of the cell contains SIB20 on the MBS frequency which the UE monitors and as long as the condition 2) above is fulfilled for the serving cell.

For example, example scenarios in which such down-prioritisation may be needed include the cases where camping is not possible for the UE on the MBS broadcast frequency (e.g. the MBS broadcast frequency belongs to a PLMN different from UE's registered PLMN) while the UE can receive the MBS broadcast service when camped on another frequency than the MBS broadcast frequency or current frequency.

For example, the frequency prioritization for MBS broadcast, NR sidelink communication, or V2X sidelink communication may override the re-selection priorities for slice-based cell reselection.

In case UE receives RRCRelease with deprioritisationReq, UE shall consider current frequency and stored frequencies due to the previously received RRCRelease with deprioritisationReq or all the frequencies of NR to be the lowest priority frequency (i.e. lower than any of the network configured values) while T325 is running irrespective of camped RAT. The UE shall delete the stored deprioritisation request(s) when a PLMN selection or SNPN selection is performed on request by NAS.

For example, UE should search for a higher priority layer for cell reselection as soon as possible after the change of priority. The minimum related performance requirements are still applicable.

For example, the UE does not consider MBS broadcast, NR sidelink communication or V2X sidelink communication functionality to replace cell reselection priorities caused by HSDN or deprioritisationReq functionality.

The UE shall delete priorities provided by dedicated signalling when:
the UE enters a different RRC state; or
the optional validity time of dedicated priorities (T320) expires; or
the UE receives an RRCRelease message with the field

cellReselectionPriorities absent; or
a PLMN selection or SNPN selection is performed on request by NAS.

For example, equal priorities between RATs are not supported.

The UE shall not consider any exclude-listed cells as candidate for cell reselection.

The UE shall consider only the allow-listed cells, if configured, as candidates for cell reselection.

The UE in RRC_IDLE state shall inherit the priorities provided by dedicated signalling and the remaining validity time (i.e. T320 in NR and E-UTRA), if configured, at inter-RAT cell (re) selection.

For example, the network may assign dedicated cell reselection priorities for frequencies not configured by system information.
Measurement rules for cell re-selection

Following rules are used by the UE to limit needed measurements:
If the serving cell fulfils Srxlev> S_{IntraSearchP} and Squal> S_{IntraSearchQ}.
If distanceThresh and referenceLocation are broadcasted in SIB19, and if UE supports location-based measurement initiation and has obtained its location information:
If the distance between UE and the serving cell reference location referenceLocation is shorter than distanceThresh, the UE may not perform intra-frequency measurements;
Else, the UE shall perform intra-frequency measurements;
Else, the UE may not perform intra-frequency measurements;
Else, the UE shall perform intra-frequency measurements.
The UE shall apply the following rules for NR inter-frequencies and inter-RAT frequencies which are indicated in system information and for which the UE has priority provided:
For a NR inter-frequency or inter-RAT frequency with a reselection priority higher than the reselection priority of the current NR frequency, the UE shall perform measurements of higher priority NR inter-frequency or inter-RAT frequencies.
For a NR inter-frequency with an equal or lower reselection priority than the reselection priority of the current NR frequency and for inter-RAT frequency with lower reselection priority than the reselection priority of the current NR frequency:
If the serving cell fulfils Srxlev> S_{nonIntraSearchP} and Squal> S_{nonIntraSearchQ}:
If distanceThresh and referenceLocation are broadcasted in SIB19, and if UE supports location-based measurement initiation and has obtained its UE location information:
If the distance between UE and the serving cell reference location referenceLocation is shorter than distanceThresh, the UE may choose not to perform measurements of NR inter-frequency cells of equal or lower priority, or inter-RAT frequency cells of lower priority;
Else, the UE shall perform measurements of NR inter-frequency cells of equal or lower priority, or inter-RAT frequency cells of lower priority;
Else, the UE may choose not to perform measurements of NR inter-frequency cells of equal or lower priority, or inter-RAT frequency cells of lower priority;
Else, the UE shall perform measurements of NR inter-frequency cells of equal or lower priority, or inter-RAT frequency cells of lower priority.
If the UE supports relaxed measurement and relaxedMeasurement is present in SIB2, the UE may further relax the needed measurements.

If the t-Service of the serving cell is present in SIB19, and if UE supports time-based measurement initiation, the UE shall perform intra-frequency, inter-frequency or inter-RAT measurements before the t-Service, regardless of the distance between UE and the serving cell reference location or whether the serving cell fulfils Srxlev> S_{IntraSearchP} and Squal> S_{IntraSearchQ}, or Srxlev> S_{nonIntraSearchP} and Squal> S_{nonIntraSearchQ}, The exact time to start measurement before t-Service is up to UE implementation. UE shall perform measurements of higher priority NR inter-frequency or inter-RAT frequencies regardless of the remaining service time of the serving cell (i.e. time remaining until t-Service).

For example, when evaluating the distance between UE and the serving cell reference location, it's up to UE implementation to obtain UE location information.

Intra-frequency and equal priority inter-frequency Cell Reselection criteria

The cell-ranking criterion Rₛ for serving cell and Rn for neighbouring cells is defined by:

$${R}_{s} = {Q}_{meas , s} + {Q}_{hyst} - {Qoffset}_{temp}$$

$${R}_{n} = {Q}_{meas , n} - Qoffset - {Qoffset}_{temp}$$

where:

Qmeas: RSRP measurement quantity used in cell reselections.

Qoffset: For intra-frequency: Equals to Qoffsets,n, if Qoffsets,n is valid, otherwise this equals to zero. For inter-frequency: Equals to Qoffsets,n plus Qoffsetfrequency, if Qoffsets,n is valid, otherwise this equals to Qoffsetfrequency.

Qoffsettemp: Offset temporarily applied to a cell.

The UE shall perform ranking of all cells that fulfil the cell selection criterion S.

The cells shall be ranked according to the R criteria specified above by deriving Q_{meas,n} and Q_{meas,s} and calculating the R values using averaged RSRP results.

If rangeToBestCell is not configured, the UE shall perform cell reselection to the highest ranked cell. If this cell is found to be not-suitable, the UE shall behave actions related to Cells with cell reservations, access restrictions or unsuitable for normal camping. If rangeToBestCell is configured, then the UE shall perform cell reselection to the cell with the highest number of beams above the threshold (i.e. absThreshSS-BlocksConsolidation) among the cells whose R value is within rangeToBestCell of the R value of the highest ranked cell. If there are multiple such cells, the UE shall perform cell reselection to the highest ranked cell among them. If this cell is found to be not-suitable, the UE shall behave actions related to Cells with cell reservations, access restrictions or unsuitable for normal camping.

In all cases, the UE shall reselect the new cell, only if the following conditions are met:
the new cell is better than the serving cell according to the cell reselection criteria specified above during a time interval TreselectionRAT;
more than 1 second has elapsed since the UE camped on the current serving cell.

For example, if rangeToBestCell is configured but absThreshSS-BlocksConsolidation is not configured on an NR frequency, the UE considers that there is one beam above the threshold for each cell on that frequency.

Hereinafter, technical features related to area-specific CPAC are described.

When the UE moves from the coverage area of one cell to another cell, at some point a serving cell change needs to be performed. Currently serving cell change is triggered by L3 measurements and is done by RRC signalling triggered Reconfiguration with Synchronisation for change of PCell and PSCell, as well as release add for SCells when applicable. All cases involve complete L2 (and L1) resets, leading to longer latency, larger overhead and longer interruption time than beam switch mobility. The goal of L1/L2 mobility enhancements is to enable a serving cell change via L1/L2 signalling, in order to reduce the latency, overhead and interruption time.

In Rel-17 Conditional PSCell change (CPC)/Conditional PSCell addition (CPA), a CPC/CPA-configured UE has to release the CPC/CPA configurations when completing random access towards the target PSCell. Hence the UE doesn't have a chance to perform subsequent CPC/CPA without prior CPC/CPA reconfiguration and re-initialization from the network. This will increase the delay for the cell change and increase the signaling overhead, especially in the case of frequent SCG changes when operating FR2. Therefore, MR-DC with selective activation of cell groups aims at enabling subsequent CPC/CPA after SCG change, without reconfiguration and re-initialization on the CPC/CPA preparation from the network. This results in a reduction of the signalling overhead and interrupting time for SCG change.

Currently, CHO and MR-DC cannot be configured simultaneously. This limits the usefulness of these two features when MR-DC is configured. If it is not completed in Rel-17, Rel-18 should specify mechanisms for CHO and MR-DC to be configured simultaneously. However, this alone may not be sufficient to optimise MR-DC mobility, as the radio link quality of the conditionally-configured PSCell may not be good enough or may not be the best candidate PSCell when the UE accesses the target PCell, and this may impact the UE throughput. To mitigate this throughput impact, Rel-18 CHO+ MRDC can consider CHO including target MCG and multiple candidate SCGs for CPC/CPA.

The detailed objective related to area-specific CPAC are:
1. To specify mechanism and procedures of L1/L2 based inter-cell mobility for mobility latency reduction:
Configuration and maintenance for multiple candidate cells to allow fast application of configurations for candidate cells [RAN2, RAN3]
Dynamic switch mechanism among candidate serving cells (including SpCell and SCell) for the potential applicable scenarios based on L1/L2 signalling [RAN2, RAN1]
L1 enhancements for inter-cell beam management, including L1 measurement and reporting, and beam indication [RAN1, RAN2]

For example, early RAN2 involvement is necessary, including the possibility of further clarifying the interaction between this bullet with the previous bullet
Timing Advance management [RAN1, RAN2]
CU-DU interface signaling to support L1/L2 mobility, if needed [RAN3]

For example, FR2 specific enhancements are not precluded, if any.

For example, the procedure of L1/L2 based inter-cell mobility are applicable to the following scenarios:
Standalone, CA and NR-DC case with serving cell change within one CG
Intra-DU case and intra-CU inter-DU case (applicable for Standalone and CA: no new RAN interfaces are expected)
Both intra-frequency and inter-frequency
Both FR1 and FR2
Source and target cells may be synchronized or non-synchronized
2. To specify mechanism and procedures of NR-DC with selective activation of the cell groups (at least for SCG) via L3 enhancements:
To allow subsequent cell group change after changing CG without reconfiguration and re-initiation of CPC/CPA [RAN2, RAN3, RAN4]

For example, a harmonized RRC modelling approach for objectives 1 and 2 could be considered to minimize the workload in RAN2.
3. For CHO including target MCG and target SCG in NR-DC [RAN3]:
to specify data forwarding optimizations; and
to specify, if needed, a solution to avoid unnecessary signaling exchange between source MN and target SN.
4. To specify CHO including target MCG and candidate SCGs for CPC/CPA in NR-DC [RAN3, RAN2]
CHO including target MCG and target SCG is used as the baseline
5. To specify RRM core requirements for the following, as necessary [RAN4]:
L1/L2-based inter-cell mobility
Enhanced CHO configurations addressed by this WI
6. To specify RF requirements to cover inter-frequency L1/L2-based mobility, as necessary [RAN4].
7. To study and specify how to reuse the IDLE/INACTIVE mode measurement results which are to be reported during and/or after RRC connection setup/resume in order to improve SCell/SCG setup delay [RAN4, RAN2], including:
Availability and validation of the IDLE/INACTIVE mode measurement results to be reported [RAN4]; and
Definition of corresponding RRM requirements [RAN4]; and
If necessary based on RAN4 outcome, definition of corresponding signalling support [RAN2].

For example, RAN4 will coordinate in due course with RAN2 to start the work.

For example, with exception of the above scenarios, enhancements on IDLE/INACTIVE mode measurements and on UE behavior in IDLE/INACTIVE mode are not in scope.

Meanwhile, when resuming the RRC connection, if UE has a stored pre-configuration associated with the resume target cell, the UE can boost the DL/UL performance by applying the pre-configuration upon RRC resume.

Thus, UE in RRC_INACTIVE is better to select a neighbor cell as a new serving cell, for which the pre-configuration is stored, if possible. However, though the pre-configuration is stored for several neighbor cells, the UE may select a neighbor cell for which no pre-configuration is stored.

Therefore, studies for cell re-selection based on pre-configuration in a wireless communication system are required.

Hereinafter, a method for cell re-selection based on pre-configuration in a wireless communication system, according to some embodiments of the present disclosure, will be described with reference to the following drawings.

The following drawings are created to explain specific embodiments of the present disclosure. The names of the specific devices or the names of the specific signals/messages/fields shown in the drawings are provided by way of example, and thus the technical features of the present disclosure are not limited to the specific names used in the following drawings. Herein, a wireless device may be referred to as a user equipment (UE).

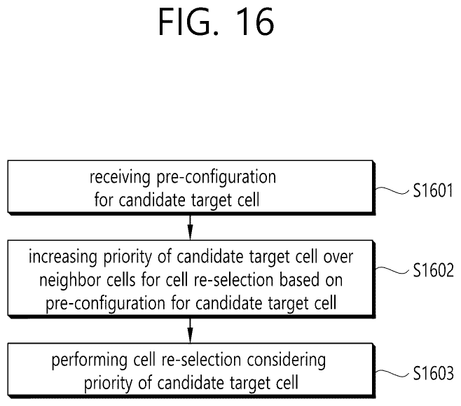

FIG. 16 shows an example of a method for cell re-selection based on pre-configuration in a wireless communication system, according to some embodiments of the present disclosure.

In particular, FIG. 16 shows an example of a method performed by a wireless device in a wireless communication system.

In step S1601, a wireless device may receive a pre-configuration for a candidate target cell

For example, the wireless device may receive the pre-configuration while in a radio resource control (RRC) CONNECTED state.

For other example, the wireless device may receive the pre-configuration while in an RRC INACTIVE state or an RRC IDLE state.

For example, the wireless device may enter an RRC INACTIVE state upon receiving an RRC release message with suspend configuration or enter an RRC IDLE state upon receiving an RRC release message.

For example, the pre-configuration for the candidate target cell may be a configuration for a conditional handover or a lower-layer triggered mobility (LTM).

For example, the pre-configuration for the candidate target cell may include an RRC reconfiguration for the candidate target cell.

In step S1602, a wireless device may increase a priority of the candidate target cell over one or more neighbor cells for cell re-selection based on the pre-configuration for the candidate target cell.

For example, the wireless device may prioritize at least one candidate target cell for which the pre-configuration is stored over one or more neighbor cells for which no pre-configuration is stored.

In other words, the wireless device may prioritize the candidate target cell over one or more neighbor cells for cell re-selection when the wireless device stores the pre-configuration for the candidate target cell.

For example, the wireless device may apply an offset for the candidate target cell for which the pre-configuration is stored (that is, a pre-configuration-based offset), while performing ranking of one or more cells for the cell re-selection.

According to some embodiments of the present disclosure, the wireless device may receive, from a network, information informing whether prioritization based on pre-configuration is allowed or not.

For example, the information may be included in an RRC release message.

For example, the information may be included in the pre-configuration for the candidate target cell.

In this case, the wireless device may increase the priority of the candidate target cell over one or more neighbor cells for cell re-selection, if the wireless device stores the pre-configuration for the candidate target cell, only when the information informing that the prioritization based on the pre-configuration is allowed.

In other words, when the information informing that the prioritization based on the pre-configuration is not allowed, the wireless device may not increase the priority of the candidate target cell over one or more neighbor cells for cell re-selection, even though the wireless device stores the pre-configuration for the candidate target cell.

According to some embodiments of the present disclosure, the pre-configuration for the candidate cell may be valid while a validity timer is running.

For example, the validity timer may be configured by the network.

For example, the validity timer may be started upon leaving a validity area. For example, the validity area may include one or more cells.

For other example, the validity timer may be started upon entering the RRC INACTIVE state or the RRC IDLE state.

For other example, the validity timer may be started upon receiving the pre-configuration.

For example, information related to the validity area and/or the validity timer may be included in the pre-configuration.

According to some embodiments of the present disclosure, the wireless device may evaluate whether an execution condition related to the pre-configuration is met.

For example, the wireless device may increase the priority of the candidate target cell over one or more neighbor cells for cell re-selection based on the pre-configuration for the candidate target cell, only when the execution condition related to the pre-configuration is met.

In other words, the priority of the candidate target cell may be increased based on the execution condition related to the pre-configuration being met.

In step S1603, a wireless device may perform cell re-selection considering the priority of the candidate target cell.

For example, the wireless device may perform cell re-selection based on the prioritized priority for the candidate target cell.

For example, the wireless device may perform cell re-selection based on applying the pre-configuration-based offset.

According to some embodiments of the present disclosure, the wireless device may be in communication with at least one of a user equipment, a network, or an autonomous vehicle other than the wireless device.

Hereinafter, technical features related to cell prioritization based on pre-configuration are described.

For cell re-selection, UE prioritizes a neighbor cell for which pre-configuration is stored over other neighbor cells for which no pre-configuration is stored.

How to prioritize neighbour cell based on pre-configuration

To prioritize a neighbor cell for which the pre-configuration is stored, UE may apply a pre-configuration-offset to the neighbor cell when performing ranking of the neighbor cell. The pre-configuration-offset is a positive number and it increases the cell-ranking criterion Rₛ of the neighbour cell for which the pre-configuration is stored.

The cell-ranking criterion Rₛ for neighbouring cell for which the pre-configuration is stored is:

$${R}_{n} = {Q}_{meas , n} - Qoffset - {Qoffset}_{temp} + pre - configuration - offset$$

The cell-ranking criterion Rₛ for neighbouring cell for which the pre-configuration is not stored is:

$${R}_{n} = {Q}_{meas , n} - Qoffset - {Qoffset}_{temp} .$$

UE may consider neighbour cells for which the pre-configuration is stored to be the highest priority (i.e., higher than any other network configured priorities).

UE may consider the frequency of neighbour cell for which the pre-configuration is stored to be the highest priority (i.e., higher than any other network configured priorities).

### Network Indication for the Prioritization

When the RRC connection is suspended, the network may indicate whether the prioritization based on the pre-configuration is allowed or not, e.g., via RRC release message.

If UE is allowed to prioritize based on the pre-configuration, the UE prioritizes neighbour cells for which the pre-configuration is stored.

If UE is not allowed to prioritize based on the pre-configuration, the UE does not prioritize neighbour cells for which the pre-configuration is stored.

In each pre-configuration, it may be indicated whether or not this pre-configuration is available in RRC_INACTIVE, i.e., whether neighbour cell can be prioritized based on this pre-configuration.

If it is indicated that a pre-configuration on a neighbour cell is available in RRC_INACTIVE, UE prioritizes the neighbour cell for cell re-selection, and/or applies the pre-configuration on the neighbour cell when resuming the RRC connection.

If it is indicated that a pre-configuration on a neighbour cell is not available in RRC_INACTIVE, UE doesn't prioritize the neighbour cell for cell re-selection, and/or doesn't apply the pre-configuration on the neighbour cell when resuming the RRC connection.

Before prioritizing a neighbour cell (or upon prioritizing a neighbour cell), UE may check whether the neighbour cell allows the prioritization based on the pre-configuration.

If a neighbour cell for which the pre-configuration is stored indicates that the cell prioritization based on the pre-configuration is allowed, the UE prioritizes the neighbour cell, and performs cell re-selection based on the restored cell priority.

If a neighbour cell for which the pre-configuration is stored indicates that the cell prioritization based on the pre-configuration is not allowed, the UE restoes the priority of the neighbour cell (or frequency of the neighbour cell), and performs cell re-selection based on the restored cell priority.
Acquisition of pre-configuration of neighbour cell

UE may receive the pre-configuration on neighbour cell while in RRC_CONNECTED state, for the purpose of mobility, such as conditional handover or LTM.

The pre-configuration on neighbour cell is a RRCReconfiguration message, or includes only essential information elements for neighbour cell configuration.
Validity of the pre-configuration

For each pre-configuration on neighbour cell, a validity timer can be configured. UE may start the validity timer upon receiving RRC release message. UE may start the validity timer upon entering RRC_INACTIVE state. UE may start the validity timer upon receiving the pre-configuration on neighbour cell. When the validity timer expires, UE may delete the stored pre-configuration on neighbour cell. UE may stop the validity timer upon entering RRC_CONNECTED, if running.

The validity area can be configured for each pre-configuration on neighbour cell. The validity area consists of a group of cells. UE may start the validity timer upon leaving the validity area. UE may delete the pre-configuration on neighbour cell upon leaving the corresponding validity area.

### Cell Prioritization Based on Execution Conditions

The pre-configuration can be associated with an execution condition. UE may prioritize a neighbour cell if the pre-configuration is stored for the neighbour cell, and if the execution condition associated with the pre-configuration (or the neighbour cell) is met.

For instance, UE receives a CHO configuration which consists of the pre-configuration on a target cell and an execution condition. After entering RRC_INACTIVE, UE keeps evaluating the execution condition is met or not. If the execution condition is met, the UE prioritizes the neighbour cell associated with the pre-configuration, and performs the cell re-selection procedure based on the prioritization.

According to some embodiments of the present disclosure, a wireless device may receive a pre-configuration on a candidate target cell. The wireless device may enter RRC INACTIVE state. The wireless device may prioritize the candidate target cell over other neighbour cells. The wireless device may perform cell re-selection based on the prioritization.

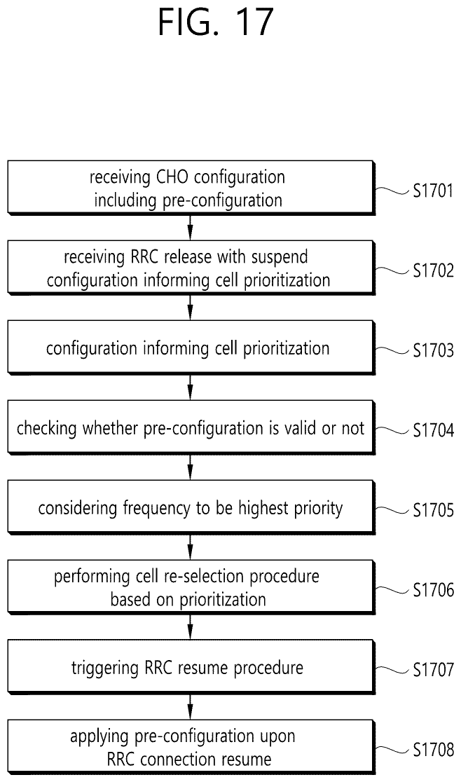

FIG. 17 shows an example of a method for cell prioritization based on pre-configuration.

In particular, FIG. 17 shows an example of a method performed by an UE in a wireless communication system.

In step S1701, the UE receives the CHO configuration for neighbour cell F.

For example, the CHO configuration includes the pre-configuration on cell F.

In step S1702, the UE receives RRC release with suspend configuration message from network, which indicates that the CHO configuration can be used for the cell prioritization in RRC_IDLE/INACTIVE.

In step S1703, the UE enters RRC_INACTIVE state and stores the pre-configuration. In step S1704, the UE checks whether the stored pre-configuration is valid or not.

In step S1705, the UE considers the frequency of cell F to be the highest priority, if the stored pre-configuration on cell F is valid.

In step S1706, the UE performs the cell re-selection procedure based on the prioritization.

In step S1707, the UE triggers an RRC resume procedure.

For example, the RRC resume is triggered while camping on cell F.

In step S1708, the UE applies the pre-configuration of cell F upon RRC connection resume.

Some of the detailed steps shown in the examples of FIGS. 16 and 17 may not be essential steps and may be omitted. In addition to the steps shown in FIGS. 16 and 17, other steps may be added, and the order of the steps may vary. Some of the above steps may have their own technical meaning.

Hereinafter, an apparatus for cell re-selection based on pre-configuration in a wireless communication system, according to some embodiments of the present disclosure, will be described. Herein, the apparatus may be a wireless device (100 or 200) in FIGS. 2, 3, and 5.

For example, a wireless device may perform methods described above. The detailed description overlapping with the above-described contents could be simplified or omitted.

Referring to FIG. 5, a wireless device 100 may include a processor 102, a memory 104, and a transceiver 106.

According to some embodiments of the present disclosure, the processor 102 may be configured to be coupled operably with the memory 104 and the transceiver 106.

The processor 102 may be adapted to receive a pre-configuration for a candidate target cell. The processor 102 may be adapted to increase a priority of the candidate target cell over one or more neighbor cells for cell re-selection based on the pre-configuration for the candidate target cell. The processor 102 may be adapted to perform cell re-selection considering the priority of the candidate target cell.

For example, the processor 102 may be adapted to enter a radio resource control (RRC) INACTIVE state or an RRC IDLE state.

For example, the processor 102 may be adapted to prioritize at least one candidate target cell for which the pre-configuration is stored over one or more neighbor cells for which no pre-configuration is stored.

For example, the processor 102 may be adapted to apply an offset for the candidate target cell for which the pre-configuration is stored, while performing ranking of one or more cells for the cell re-selection.

For example, the processor 102 may be adapted to receive, from a network, information informing whether prioritization based on pre-configuration is allowed or not.

For example, the information may be included in an RRC release message.

For example, the information may be included in the pre-configuration for the candidate target cell.

For example, the pre-configuration for the candidate target cell may be a configuration for a conditional handover or a lower-layer triggered mobility (LTM).

For example, the pre-configuration for the candidate target cell may include an RRC reconfiguration for the candidate target cell.

For example, the pre-configuration for the candidate cell may be valid while a validity timer is running.

For example, the validity timer may be started upon leaving a validity area.

For example, the processor 102 may be adapted to evaluate whether an execution condition related to the pre-configuration is met.

For example, the priority of the candidate target cell may be increased based on the execution condition related to the pre-configuration being met.

For example, the processor 102 may be adapted to be in communication with at least one of a user equipment, a network, or an autonomous vehicle other than the wireless device.

Hereinafter, a processor for a wireless device for cell re-selection based on pre-configuration in a wireless communication system, according to some embodiments of the present disclosure, will be described.

The processor may be adapted to control the wireless device to receive a pre-configuration for a candidate target cell. The processor may be adapted to control the wireless device to increase a priority of the candidate target cell over one or more neighbor cells for cell re-selection based on the pre-configuration for the candidate target cell. The processor may be adapted to control the wireless device to perform cell re-selection considering the priority of the candidate target cell.

For example, the processor may be adapted to control the wireless device to enter a radio resource control (RRC) INACTIVE state or an RRC IDLE state.

For example, the processor may be adapted to control the wireless device to prioritize at least one candidate target cell for which the pre-configuration is stored over one or more neighbor cells for which no pre-configuration is stored.

For example, the processor may be adapted to control the wireless device to apply an offset for the candidate target cell for which the pre-configuration is stored, while performing ranking of one or more cells for the cell re-selection.

For example, the processor may be adapted to control the wireless device to receive, from a network, information informing whether prioritization based on pre-configuration is allowed or not.

For example, the information may be included in an RRC release message.

For example, the information may be included in the pre-configuration for the candidate target cell.

For example, the pre-configuration for the candidate target cell may be a configuration for a conditional handover or a lower-layer triggered mobility (LTM).

For example, the pre-configuration for the candidate target cell may include an RRC reconfiguration for the candidate target cell.

For example, the pre-configuration for the candidate cell may be valid while a validity timer is running.

For example, the validity timer may be started upon leaving a validity area.

For example, the processor may be adapted to control the wireless device to evaluate whether an execution condition related to the pre-configuration is met.

For example, the priority of the candidate target cell may be increased based on the execution condition related to the pre-configuration being met.

For example, the processor may be adapted to control the wireless device to be in communication with at least one of a user equipment, a network, or an autonomous vehicle other than the wireless device.

Hereinafter, a non-transitory computer-readable medium has stored thereon a plurality of instructions for cell re-selection based on pre-configuration in a wireless communication system, according to some embodiments of the present disclosure, will be described.

According to some embodiment of the present disclosure, the technical features of the present disclosure could be embodied directly in hardware, in a software executed by a processor, or in a combination of the two. For example, a method performed by a wireless device in a wireless communication may be implemented in hardware, software, firmware, or any combination thereof. For example, a software may reside in RAM memory, flash memory, ROM memory, EPROM memory, EEPROM memory, registers, hard disk, a removable disk, a CD-ROM, or any other storage medium.

Some example of storage medium is coupled to the processor such that the processor can read information from the storage medium. In the alternative, the storage medium may be integral to the processor. The processor and the storage medium may reside in an ASIC. For another example, the processor and the storage medium may reside as discrete components.

The computer-readable medium may include a tangible and non-transitory computer-readable storage medium.

For example, non-transitory computer-readable media may include random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, or any other medium that can be used to store instructions or data structures. Non-transitory computer-readable media may also include combinations of the above.

In addition, the method described herein may be realized at least in part by a computer-readable communication medium that carries or communicates code in the form of instructions or data structures and that can be accessed, read, and/or executed by a computer.

According to some embodiment of the present disclosure, a non-transitory computer-readable medium has stored thereon a plurality of instructions. The stored a plurality of instructions may be executed by a processor of a wireless device.

The stored a plurality of instructions may cause the wireless device to receive a pre-configuration for a candidate target cell. The stored a plurality of instructions may cause the wireless device to increase a priority of the candidate target cell over one or more neighbor cells for cell re-selection based on the pre-configuration for the candidate target cell. The stored a plurality of instructions may cause the wireless device to perform cell re-selection considering the priority of the candidate target cell.

For example, the stored a plurality of instructions may cause the wireless device to enter a radio resource control (RRC) INACTIVE state or an RRC IDLE state.

For example, the stored a plurality of instructions may cause the wireless device to prioritize at least one candidate target cell for which the pre-configuration is stored over one or more neighbor cells for which no pre-configuration is stored.

For example, the stored a plurality of instructions may cause the wireless device to apply an offset for the candidate target cell for which the pre-configuration is stored, while performing ranking of one or more cells for the cell re-selection.

For example, the stored a plurality of instructions may cause the wireless device to receive, from a network, information informing whether prioritization based on pre-configuration is allowed or not.

For example, the information may be included in an RRC release message.

For example, the information may be included in the pre-configuration for the candidate target cell.

For example, the pre-configuration for the candidate target cell may be a configuration for a conditional handover or a lower-layer triggered mobility (LTM).

For example, the pre-configuration for the candidate target cell may include an RRC reconfiguration for the candidate target cell.

For example, the pre-configuration for the candidate cell may be valid while a validity timer is running.

For example, the validity timer may be started upon leaving a validity area.

For example, the stored a plurality of instructions may cause the wireless device to evaluate whether an execution condition related to the pre-configuration is met.

For example, the priority of the candidate target cell may be increased based on the execution condition related to the pre-configuration being met.

For example, the stored a plurality of instructions may cause the wireless device to be in communication with at least one of a user equipment, a network, or an autonomous vehicle other than the wireless device.

Hereinafter, a method performed by a base station (BS) for cell re-selection based on pre-configuration in a wireless communication system, according to some embodiments of the present disclosure, will be described.

The BS may transmit, to a wireless device, a pre-configuration for a candidate target cell. In this case, the wireless device may increase a priority of the candidate target cell over one or more neighbor cells for cell re-selection based on the pre-configuration for the candidate target cell. The wireless device may perform cell re-selection considering the priority of the candidate target cell.

Hereinafter, a base station (BS) for cell re-selection based on pre-configuration in a wireless communication system, according to some embodiments of the present disclosure, will be described.

The BS may include a transceiver, a memory, and a processor operatively coupled to the transceiver and the memory.

The processor may be adapted to control the transceiver to transmit, to a wireless device, a pre-configuration for a candidate target cell. In this case, the wireless device may increase a priority of the candidate target cell over one or more neighbor cells for cell re-selection based on the pre-configuration for the candidate target cell. The wireless device performs cell re-selection considering the priority of the candidate target cell.

The present disclosure can have various advantageous effects.

According to some embodiments of the present disclosure, the wireless device could perform cell re-selection efficiently by considering pre-configuration.

For example, a wireless device can apply the configuration which is optimized for the resume target cell (for example, CA or DC), upon RRC resume by selecting a cell for which the pre-configuration is stored.

In other words, a wireless device can increasing priority of a specific cell, when the wireless device has the pre-configuration for the specific cell. Thus, the wireless device could efficiently perform cell re-selection considering the stored pre-configuration.

According to some embodiments of the present disclosure, the wireless communication system could provide an efficient solution for cell re-selection considering pre-configuration.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1. A method, comprising:
receiving, by a wireless device, a pre-configuration for a candidate target cell;
increasing, by the wireless device, a priority of the candidate target cell over one or more neighbor cells for cell re-selection based on the pre-configuration for the candidate target cell; and
performing, by the wireless device, cell re-selection considering the priority of the candidate target cell.

2. The method of claim 1, wherein the method further comprises,
entering, by the wireless device, a radio resource control (RRC) INACTIVE state or an RRC IDLE state.

3. The method of claim 1, wherein the method further comprises,
prioritizing, by the wireless device, at least one candidate target cell for which the pre-configuration is stored over one or more neighbor cells for which no pre-configuration is stored.

4. The method of claim 1, wherein the method further comprises,
applying, by the wireless device, an offset for the candidate target cell for which the pre-configuration is stored, while performing ranking of one or more cells for the cell re-selection.

5. The method of claim 1, wherein the method further comprises,
receiving, by the wireless device from a network, information informing whether prioritization based on pre-configuration is allowed or not.

6. The method of claim 5,
wherein the information is included in an RRC release message.

7. The method of claim 5,
wherein the information is included in the pre-configuration for the candidate target cell.

8. The method of claim 1,
wherein the pre-configuration for the candidate target cell is a configuration for a conditional handover or a lower-layer triggered mobility (LTM).

9. The method of claim 1,
wherein the pre-configuration for the candidate target cell includes an RRC reconfiguration for the candidate target cell.

10. The method of claim 1,
wherein the pre-configuration for the candidate cell is valid while a validity timer is running.

11. The method of claim 10,
wherein the validity timer is started upon leaving a validity area.

12. The method of claim 1, wherein the method further comprises,
evaluating, by the wireless device, whether an execution condition related to the pre-configuration is met.

13. The method of claim 1,
wherein the priority of the candidate target cell is increased based on the execution condition related to the pre-configuration being met.

14. The method of claim 1,
wherein the wireless device is in communication with at least one of a user equipment, a network, or an autonomous vehicle other than the wireless device.

15. A wireless device, comprising:
a transceiver;
a memory; and
at least one processor operatively coupled to the transceiver and the memory, and adapted to:
receive a pre-configuration for a candidate target cell;
increase a priority of the candidate target cell over one or more neighbor cells for cell re-selection based on the pre-configuration for the candidate target cell; and
perform cell re-selection considering the priority of the candidate target cell.

16. The wireless device of claim 15, wherein the at least one processor is further adapted to,
enter a radio resource control (RRC) INACTIVE state or an RRC IDLE state.

17. The wireless device of claim 15, wherein the at least one processor is further adapted to,
prioritize at least one candidate target cell for which the pre-configuration is stored over one or more neighbor cells for which no pre-configuration is stored.

18. The wireless device of claim 15, wherein the at least one processor is further adapted to,
apply an offset for the candidate target cell for which the pre-configuration is stored, while performing ranking of one or more cells for the cell re-selection.

19. The wireless device of claim 15, wherein the at least one processor is further adapted to,
receive, from a network, information informing whether prioritization based on pre-configuration is allowed or not.

20.-31. (canceled)

32. A base station in a wireless communication system comprising:
a transceiver;
a memory; and
a processor operatively coupled to the transceiver and the memory, and adapted to:
transmit, to a wireless device, a pre-configuration for a candidate target cell,
wherein the wireless device increases a priority of the candidate target cell over one or more neighbor cells for cell re-selection based on the pre-configuration for the candidate target cell; and
wherein the wireless device performs cell re-selection considering the priority of the candidate target cell.
